(19) United States
(12) Patent Application Publication
(10) Pub. No.: US 2023/0052129 A1
(43) Pub. Date: Feb. 16, 2023

(54) ENERGY STORAGE SYSTEM AND CONTROL METHOD THEREOF

(71) Applicant: Huawei Digital Power Technologies Co., Ltd., Shenzhen (CN)

(72) Inventors: Lin LI, Shanghai (CN); Haibin GUO, Shanghai (CN); He ZHOU, Shanghai (CN)

(73) Assignee: Huawei Digital Power Technologies Co., Ltd., Shenzhen (CN)

(21) Appl. No.: 17/886,128

(22) Filed: Aug. 11, 2022

(30) Foreign Application Priority Data
Aug. 13, 2021 (CN) 202110929718.9

(51) Int. Cl. H02J 7/00

(52) U.S. Cl. CPC H02J 7/00712; H02J 7/00036; H02J 7/0048

(57) ABSTRACT

An energy storage system includes N switch units and N battery packs connected in series. The N switch units are separately connected to two ends of the N battery packs in a one-to-one correspondence. Each of the N switch units is configured to: when the energy storage system is in a charging state and remaining power of a battery pack correspondingly connected to each switch unit meets a first preset condition, and/or when the energy storage system is in a discharging state and the remaining power of the battery pack correspondingly connected to each switch unit meets a second preset condition, perform disconnection processing on the battery pack correspondingly connected to each switch unit. The first preset condition includes being greater than or equal to a first preset power value. The second preset condition includes being less than or equal to a second preset power value.

### CROSS-REFERENCE TO RELATED APPLICATION

This application claims priority to Chinese Patent Application No. 202110929718.9, filed on Aug. 13, 2021, which is hereby incorporated by reference in its entirety.

### TECHNICAL FIELD

This application relates to the field of energy technologies, and in particular, to an energy storage system and a control method thereof.

### BACKGROUND

Due to fluctuations in, and uncertainty of energy-based power generation, an energy storage system needs to be added to store excess electric energy in order to meet the requirement of a continuous power supply to users. An existing energy system mainly includes an energy management system (EMS), a battery control unit (BCU), an energy storage rack, a direct current/direct current (DC/DC) converter, a direct current/alternating current (DC/AC) converter, an energy-based power generation system, a power grid, and a load. The energy storage rack is mainly used for storing electric energy.

In a conventional technology, the energy storage rack is connected to a bus bar by using the DC/DC converter, and then the DC/AC converter is connected to the power grid or supplies power to the load, or the energy-based power generation system is connected to an alternating current side, and charges the energy storage rack by using the DC/AC converter and the DC/DC converter.

Generally, the energy storage rack includes a plurality of battery packs connected in series. During charging or discharging of the battery packs, some battery packs have electricity that cannot be released, and some battery packs have little electricity but cannot be charged. As a result, power backup duration is limited.

### SUMMARY

This application provides an energy storage system and a control method thereof. According to technical solutions of this application, the energy storage system can implement a long power backup duration.

According to a first aspect, this application provides an energy storage system. The energy storage system includes N switch units and N battery packs connected in series. The N switch units are separately connected to two ends of the N battery packs in a one-to-one correspondence. N is an integer greater than 1. Each of the N switch units is configured to: when the energy storage system is in a charging state and the remaining power of a battery pack correspondingly connected to each switch unit meets a first preset condition, and/or when the energy storage system is in a discharging state and the remaining power of the battery pack correspondingly connected to each switch unit meets a second preset condition, perform disconnection processing on the battery pack correspondingly connected to each switch unit. The first preset condition includes being greater than or equal to a first preset power value. The disconnection processing includes disconnecting a current path of the battery pack correspondingly connected to each switch unit and ensuring that a current path of the energy storage system is connected. The second preset condition includes being less than or equal to a second preset power value. The first preset power value is greater than the second preset power value.

In this aspect, in a process in which the energy storage system performs charging or discharging, a corresponding switch unit is controlled to perform disconnection processing on a battery pack corresponding to the switch unit and that meets the first preset condition or a battery pack corresponding to the switch unit and that meets the second preset condition, and other battery packs continue to be charged or discharged. Finally, all the battery packs reach a same value. When the energy storage system performs charging or discharging again, because the battery energy is the same, a time for completing the charging or discharging is basically the same. In this way, a long power backup duration of the energy storage system can be implemented.

Further, after the battery pack meets the first preset condition or the battery pack meets the second preset condition is off, another battery pack in the energy storage system may still be charged or discharged at a maximum current without being affected by the battery pack being off. In this way, the problem of limited power can be resolved.

With reference to the first aspect, in a first possible implementation, the energy storage system further includes N battery monitor units BMUs. The N BMUs, the N battery packs, and the N switch units are in a one-to-one correspondence with each other. Each of the N BMUs is configured to: monitor the remaining power of a battery pack correspondingly connected to each BMU, and when the energy storage system is in a charging state and the remaining power of the battery pack correspondingly connected to each BMU meets the first preset condition, and/or when the energy storage system is in a discharging state and the remaining power of the battery pack correspondingly connected to each BMU meets the second preset condition, send a control signal to a switch unit correspondingly connected to each BMU. The control signal is used for controlling the switch unit correspondingly connected to each BMU to perform the disconnection processing on the battery pack correspondingly connected to each BMU. Each switch unit is specifically configured to: receive the control signal sent by the BMU correspondingly connected to each switch unit, and perform, under control of the control signal, the disconnection processing on the battery pack correspondingly connected to each switch unit.

In this implementation, the N BMUs are added to the energy storage system, and are separately in a one-to-one correspondence with the N battery packs and the N switch units. Each BMU monitors a status of the battery pack correspondingly connected to each BMU, so that data of the remaining power of the correspondingly connected battery pack obtained through monitoring is more accurate, and the correspondingly connected switch unit is also more accurately controlled.

With reference to the first possible implementation, in a second possible implementation, each of the N switch units includes a first switch and a second switch. Each of the N battery packs is connected in series to a first switch in a switch unit correspondingly connected to each battery pack, to obtain a sub-circuit corresponding to each battery pack. A second switch in the switch unit correspondingly connected to each battery pack is connected in parallel to the sub-circuit corresponding to each battery pack. Each BMU is separately connected to a first switch and a second switch in the switch unit correspondingly connected to each BMU. Each BMU is specifically configured to: when the energy storage system is in a charging state and the remaining power of the battery pack correspondingly connected to each BMU meets the first preset condition, and/or when the energy storage system is in a discharging state and the remaining power of the battery pack correspondingly connected to each BMU meets the second preset condition, send a first control signal to the first switch in the switch unit correspondingly connected to each BMU, and send a second control signal to the second switch in the switch unit correspondingly connected to each BMU. The first control signal is used for controlling a switch to be turned off. The second control signal is used for controlling a switch to be turned on. The first switch in each switch unit is configured to: receive the first control signal sent by the BMU correspondingly connected to each switch unit, and be turned off under control of the first control signal. The second switch in each switch unit is configured to: receive the second control signal sent by the BMU correspondingly connected to each switch unit, and be turned on under control of the second control signal.

In this implementation, the first control signal and the second control signal that are sent by the BMU correspondingly connected to each switch unit are received, and the first switch is controlled to be turned off and the second switch is controlled to be turned on, to perform disconnection on the battery pack correspondingly connected to the BMU from the current path; or the first switch is controlled to be turned on and the second switch is controlled to be turned off, to switch the battery pack correspondingly connected to each switch unit to the current path.

With reference to the second possible implementation, in a third possible implementation, the energy storage system further includes a battery control unit BCU. The BCU is connected to each BMU. Each BMU is further configured to: send power indication information corresponding to each BMU to the BCU. The power indication information indicates the remaining power of the battery pack correspondingly connected to each BMU. The BCU is configured to: receive the power indication information sent by each BMU, and determine, based on the power indication information, whether the remaining power of the battery pack correspondingly connected to each BMU meets the first preset condition or the second preset condition, when the remaining power of the battery pack correspondingly connected to each BMU meets the first preset condition and the energy storage system is in a charging state, and/or when the remaining power of the battery pack correspondingly connected to each BMU meets the second preset condition and the energy storage system is in a discharging state, send control indication information to each BMU. The control indication information indicates to the BMU to control the correspondingly connected switch unit to perform disconnection processing on the correspondingly connected battery pack. Each BMU is specifically configured to: receive the control indication information sent by the BCU, and send, based on the control indication information, the first control signal to the first switch in the switch unit correspondingly connected to each BMU, and send the second control signal to the second switch in the switch unit correspondingly connected to each BMU.

In the energy storage system, the battery control unit BCU is added to perform data communication with each BMU, to more accurately control the energy storage system.

With reference to the third possible implementation, in a fourth possible implementation, the BCU is further configured to: determine, at a startup phase of the BCU, whether the energy storage system needs to perform charging, and when the energy storage system needs to perform charging, send the control indication information to a BMU correspondingly connected to a charge-disabled battery pack in the N battery packs. The charge-disabled battery pack includes a battery pack whose remaining power is greater than or equal to the first preset power value.

With reference to the third possible implementation, in a fifth possible implementation, the BCU is further configured to: determine, at a startup phase of the BCU, whether the energy storage system needs to perform discharging, and when the energy storage system needs to perform discharging, send the control indication information to a BMU correspondingly connected to a discharge-disabled battery pack in the N battery packs. The discharge-disabled battery pack includes a battery pack whose remaining power is less than or equal to the second preset power value.

With reference to the third possible implementation, in a sixth possible implementation, the BCU is further configured to: determine, at a startup phase of the BCU, whether the energy storage system needs to perform charging and whether the energy storage system needs to perform discharging, and when the energy storage system does not need to perform charging and does not need to perform discharging, determine whether a quantity S of operational battery packs in the N battery packs is greater than or equal to a minimum quantity M of battery packs required for running the energy storage system. The operational battery packs include battery packs other than a charge-disabled battery pack, a discharge-disabled battery pack, and a faulty battery pack in the energy storage system. The charge-disabled battery pack includes a battery pack whose remaining power is greater than or equal to the first preset power value. The discharge-disabled battery pack includes a battery pack whose remaining power is less than or equal to the second preset power value. The BCU is further configured to: when S is greater than or equal to M, send the control indication information to the BMUs correspondingly connected to the charge-disabled battery pack and the discharge-disabled battery pack.

In this implementation, when the quantity of operational battery packs in the energy storage system is greater than or equal to the minimum quantity of battery packs required for running the energy storage system, the charge-disabled battery pack and the discharge-disabled battery pack in the energy storage system are off, so that after the system is started, a condition that the system can perform charging or discharging is met.

With reference to the sixth possible implementation, in a seventh possible implementation, the BCU is further configured to: when S is less than M, determine whether a sum of S and a quantity N1 of charge-disabled battery packs in the energy storage system is greater than or equal to M, and when the sum of S and N1 is greater than or equal to M, send the control indication information to the BMU correspondingly connected to the discharge-disabled battery pack.

With reference to the sixth possible implementation, in an eighth possible implementation, the BCU is further configured to: when S is less than M, determine whether a sum of S and a quantity N2 of discharge-disabled battery packs in the energy storage system is greater than or equal to M, and when the sum of S and N2 is greater than or equal to M, send the control indication information to the BMU correspondingly connected to the charge-disabled battery pack.

According to a second aspect, this application provides a control method for an energy storage system. The energy storage system includes a battery control unit BCU, N battery monitor units BMUs, N switch units, and N battery packs connected in series. The N BMUs, the N battery packs, and the N switch units are in a one-to-one correspondence with each other. N is an integer greater than 1. The control method includes: The BCU receives power indication information sent by each BMU; the BCU determines, based on the power indication information, whether the remaining power of a battery pack correspondingly connected to each BMU meets a first preset condition or a second preset condition; when the remaining power of the battery pack correspondingly connected to each BMU meets the first preset condition and the energy storage system is in a charging state, and/or when the remaining power of the battery pack correspondingly connected to each BMU meets the second preset condition and the energy storage system is in a discharging state, the BCU sends control indication information to each BMU. The power indication information indicates the remaining power of the battery pack correspondingly connected to each BMU. The control indication information indicates to the BMU to control a correspondingly connected switch unit to perform disconnection processing on the correspondingly connected battery pack. The disconnection processing includes disconnecting a current path of a battery pack correspondingly connected to each switch unit and ensuring that a current path of the energy storage system is connected.

In this aspect, the battery control unit BCU performs data communication with each BMU, to control the energy storage system more accurately. In the operation of the energy storage system, when the remaining power of the battery pack correspondingly connected to each BMU meets the first preset condition or the second preset condition, the BCU sends the control indication information to each correspondingly connected BMU. The control indication information indicates to the BMU to control the correspondingly connected switch unit to perform disconnection processing on the correspondingly connected battery pack, and other battery packs continue to be charged and discharged. Finally, all the battery packs reach a same value. Then, when the energy storage system performs charging or discharging again, energy of the battery packs is the same. In this way, a long power backup duration of the energy storage system can be implemented.

With reference to the second aspect, in a first possible implementation, the method further includes: The BCU determines, at a startup phase of the BCU, whether the energy storage system needs to perform charging; and when the energy storage system needs to perform charging, the BCU sends the control indication information to a BMU correspondingly connected to a charge-disabled battery pack in the N battery packs. The charge-disabled battery pack includes a battery pack whose remaining power is greater than or equal to a first preset power value.

With reference to the second aspect, in a second possible implementation, the method further includes: The BCU determines, at a startup phase of the BCU, whether the energy storage system needs to perform discharging; and when the energy storage system needs to perform discharging, the BCU sends the control indication information to a BMU correspondingly connected to a discharge-disabled battery pack in the N battery packs. The discharge-disabled battery pack includes a battery pack whose remaining power is less than or equal to a second preset power value.

With reference to the second aspect, in a third possible implementation, the method further includes: The BCU determines, at a startup phase of the BCU, whether the energy storage system needs to perform charging and whether the energy storage system needs to perform discharging; when the energy storage system does not need to perform charging and does not need to perform discharging, the BCU determines whether a quantity S of operational battery packs in the N battery packs is greater than or equal to a minimum quantity M of battery packs required for running the energy storage system, where the operational battery packs include battery packs other than a charge-disabled battery pack, a discharge-disabled battery pack, and a faulty battery pack in the energy storage system; and the charge-disabled battery pack includes a battery pack whose remaining power is greater than or equal to the first preset power value, and the discharge-disabled battery pack includes a battery pack whose remaining power is less than or equal to the second preset power value; and when S is greater than or equal to M, the BCU sends the control indication information to BMUs correspondingly connected to the charge-disabled battery pack and the discharge-disabled battery pack.

With reference to the third possible implementation, in a fourth possible implementation, the method further includes: When S is less than M, the BCU determines whether a sum of S and a quantity N1 of charge-disabled battery packs in the energy storage system is greater than or equal to M; and when the sum of S and N1 is greater than or equal to M, the BCU sends the control indication information to the BMU correspondingly connected to the discharge-disabled battery pack.

With reference to the third possible implementation, in a fifth possible implementation, the method further includes: When S is less than M, the BCU determines whether a sum of S and a quantity N2 of discharge-disabled battery packs in the energy storage system is greater than or equal to M; and when the sum of S and N2 is greater than or equal to M, the BCU sends the control indication information to the BMU correspondingly connected to the charge-disabled battery pack.

According to a third aspect, this application provides a control method for an energy storage system. The energy storage system includes N battery monitor units BMUs, N switch units, and N battery packs connected in series. The N BMUs, the N battery packs, and the N switch units are in a one-to-one correspondence with each other. N is an integer greater than 1. The control method includes: Each of the N BMUs monitors remaining power of a battery pack correspondingly connected to each BMU; and when the energy storage system is in a charging state and the remaining power of the battery pack correspondingly connected to each BMU meets a first preset condition, and/or when the energy storage system is in a discharging state and the remaining power of the battery pack correspondingly connected to each BMU meets a second preset condition, each BMU sends a control signal to a switch unit correspondingly connected to each BMU. The control signal is used for controlling the switch unit correspondingly connected to each BMU to perform disconnection processing on the battery pack correspondingly connected to each BMU. The disconnection processing includes disconnecting a current path of a battery pack correspondingly connected to each switch unit and ensuring that a current path of the energy storage system is connected.

According to the control method, in the operation of the energy storage system, disconnection processing is performed on a battery pack that meets the first preset condition or a battery pack that meets the second preset condition, and other battery packs continue to be charged or discharged. Finally, all the battery packs reach a same value. When the energy storage system performs charging or discharging again, because the battery energy is the same, a time for completing the charging or discharging is basically the same. In this way, a long power backup duration of the energy storage system can be implemented.

With reference to the third aspect, in a first possible implementation, each of the N switch units includes a first switch and a second switch. Each BMU is separately connected to a first switch and a second switch in the switch unit correspondingly connected to each BMU. Each of the N battery packs is connected in series to a first switch in the switch unit correspondingly connected to each battery pack, to obtain a sub-circuit corresponding to each battery pack. A second switch in the switch unit correspondingly connected to each battery pack is connected in parallel to the sub-circuit corresponding to each battery pack. That each BMU sends a control signal to a switch unit correspondingly connected to each BMU includes: when the energy storage system is in a charging state and the remaining power of the battery pack correspondingly connected to each BMU meets the first preset condition, and/or when the energy storage system is in a discharging state and the remaining power of the battery pack correspondingly connected to each BMU meets the second preset condition, sending a first control signal to the first switch in the switch unit correspondingly connected to each BMU, and sending a second control signal to the second switch in the switch unit correspondingly connected to each BMU. The first control signal is used for controlling a switch to be turned off. The second control signal is used for controlling a switch to be turned on.

With reference to the first possible implementation, in a second possible implementation, the energy storage system further includes a battery control unit BCU. The method further includes: Each BMU receives control indication information sent by the BCU. The control indication information indicates to the BMU to control the correspondingly connected switch unit to perform disconnection processing on the correspondingly connected battery pack. That each BMU sends a first control signal to the first switch in the switch unit correspondingly connected to each BMU, and sends a second control signal to the second switch in the switch unit correspondingly connected to each BMU includes: Each BMU sends, based on the control indication information, the first control signal to the first switch in the switch unit correspondingly connected to each BMU, and sends the second control signal to the second switch in the switch unit correspondingly connected to each BMU.

According to a fourth aspect, this application provides a control apparatus for an energy storage system. The energy storage system includes a battery control unit BCU, N battery monitor units BMUs, N switch units, and N battery packs connected in series. The N BMUs, the N battery packs, and the N switch units are in a one-to-one correspondence with each other. N is an integer greater than 1. The control apparatus includes: a receiving module, for the BCU to receive power indication information sent by each BMU; a determining module, for the BCU to determine, based on the power indication information, whether the remaining power of a battery pack correspondingly connected to each BMU meets a first preset condition or a second preset condition; and a sending module, when the remaining power of the battery pack correspondingly connected to each BMU meets the first preset condition and the energy storage system is in a charging state, and/or when the remaining power of the battery pack correspondingly connected to each BMU meets the second preset condition and the energy storage system is in a discharging state, for the BCU to send control indication information to each BMU. The power indication information indicates the remaining power of the battery pack correspondingly connected to each BMU. The control indication information indicates to the BMU to control a correspondingly connected switch unit to perform disconnection processing on the correspondingly connected battery pack. The disconnection processing includes disconnecting a current path of a battery pack correspondingly connected to each switch unit and ensuring that a current path of the energy storage system is connected.

With reference to the fourth aspect, in a first possible implementation, the determining module is further for the BCU to determine, at a startup phase of the BCU, whether the energy storage system needs to perform charging. The sending module is further for, when the energy storage system needs to perform charging, the BCU to send the control indication information to a BMU correspondingly connected to a charge-disabled battery pack in the N battery packs. The charge-disabled battery pack includes a battery pack whose remaining power is greater than or equal to a first preset power value.

With reference to the fourth aspect, in a second possible implementation, the determining module is further for the BCU to determine, at a startup phase of the BCU, whether the energy storage system needs to perform discharging. The sending module is further for, when the energy storage system needs to perform discharging, the BCU to send the control indication information to a BMU correspondingly connected to a discharge-disabled battery pack in the N battery packs. The discharge-disabled battery pack includes a battery pack whose remaining power is less than or equal to a second preset power value.

With reference to the fourth aspect, in a third possible implementation, the determining module is further for the BCU to determine, at a startup phase of the BCU, whether the energy storage system needs to perform charging and whether the energy storage system needs to perform discharging; and when the energy storage system does not need to perform charging and does not need to perform discharging, for the BCU to determine whether a quantity S of operational battery packs in the N battery packs is greater than or equal to a minimum quantity M of battery packs required for running the energy storage system. The operational battery packs include battery packs other than a charge-disabled battery pack, a discharge-disabled battery pack, and a faulty battery pack in the energy storage system. The charge-disabled battery pack includes a battery pack whose remaining power is greater than or equal to the first preset power value. The discharge-disabled battery pack includes a battery pack whose remaining power is less than or equal to the second preset power value. The sending module is further for, when S is greater than or equal to M, the BCU to send the control indication information to BMUs correspondingly connected to the charge-disabled battery pack and the discharge-disabled battery pack.

With reference to the third possible implementation, in a fourth possible implementation, the determining module is further for, when S is less than M, the BCU to determine whether a sum of S and a quantity N1 of charge-disabled battery packs in the energy storage system is greater than or equal to M. The sending module is further for, when the sum of S and N1 is greater than or equal to M, the BCU to send the control indication information to the BMU correspondingly connected to the discharge-disabled battery pack.

With reference to the third possible implementation, in a fifth possible implementation, the determining module is further for, when S is less than M, the BCU to determine whether a sum of S and a quantity N2 of discharge-disabled battery packs in the energy storage system is greater than or equal to M. The sending module is further for, when the sum of S and N2 is greater than or equal to M, the BCU to send the control indication information to the BMU correspondingly connected to the charge-disabled battery pack.

According to a fifth aspect, this application provides a control method for an energy storage system. The energy storage system includes N battery monitor units BMUs, N switch units, and N battery packs connected in series. The N BMUs, the N battery packs, and the N switch units are in a one-to-one correspondence with each other. N is an integer greater than 1. A control apparatus includes: a monitoring module, for each of the N BMUs to monitor the remaining power of a battery pack correspondingly connected to each BMU; and a sending module, when the energy storage system is in a charging state and the remaining power of the battery pack correspondingly connected to each BMU meets a first preset condition, and/or when the energy storage system is in a discharging state and the remaining power of the battery pack correspondingly connected to each BMU meets a second preset condition, for each BMU to send a control signal to a switch unit correspondingly connected to each BMU. The control signal is used for controlling the switch unit correspondingly connected to each BMU to perform disconnection processing on the battery pack correspondingly connected to each BMU. The disconnection processing includes disconnecting a current path of a battery pack correspondingly connected to each switch unit and ensuring that a current path of the energy storage system is connected.

According to the control method, in the operation of the energy storage system, disconnection processing is performed on a battery pack that meets the first preset condition or a battery pack that meets the second preset condition, and other battery packs continue to be charged or discharged. Finally, all the battery packs reach a same value. When the energy storage system performs charging or discharging again, because the battery energy is the same, a time for completing the charging or discharging is basically the same. In this way, a long power backup duration of the energy storage system can be implemented.

With reference to the fifth aspect, in a first possible implementation, each of the N switch units includes a first switch and a second switch. Each BMU is separately connected to a first switch and a second switch in the switch unit correspondingly connected to each BMU. Each of the N battery packs is connected in series to a first switch in the switch unit correspondingly connected to each battery pack, to obtain a sub-circuit corresponding to each battery pack. A second switch in the switch unit correspondingly connected to each battery pack is connected in parallel to the sub-circuit corresponding to each battery pack. The sending module is specifically for: that each BMU sends a control signal to a switch unit correspondingly connected to each BMU including: when the energy storage system is in a charging state and the remaining power of the battery pack correspondingly connected to each BMU meets the first preset condition, and/or when the energy storage system is in a discharging state and the remaining power of the battery pack correspondingly connected to each BMU meets the second preset condition, sending a first control signal to the first switch in the switch unit correspondingly connected to each BMU, and sending a second control signal to the second switch in the switch unit correspondingly connected to each BMU. The first control signal is used for controlling a switch to be turned off. The second control signal is used for controlling a switch to be turned on.

With reference to the first possible implementation, in a second possible implementation, the energy storage system further includes a battery control unit BCU. The apparatus further includes a receiving module, for each BMU to receive control indication information sent by the BCU. The control indication information indicates to the BMU to control the correspondingly connected switch unit to perform disconnection processing on the correspondingly connected battery pack. The sending module is specifically for: that each BMU sends a first control signal to the first switch in the switch unit correspondingly connected to each BMU, and sends a second control signal to the second switch in the switch unit correspondingly connected to each BMU including: Each BMU sends, based on the control indication information, the first control signal to the first switch in the switch unit correspondingly connected to each BMU, and sends the second control signal to the second switch in the switch unit correspondingly connected to each BMU.

According to a sixth aspect, this application provides a computer-readable storage medium. The storage medium stores a computer program or instructions. When the computer program or the instructions is or are executed by a processor, the method according to any one of the second aspect, the third aspect, or the possible implementations thereof is implemented.

According to a seventh aspect, this application provides a computer program product. The computer program product includes computer program code. When the computer program code runs on a computer, the computer is enabled to implement the method according to any one of the second aspect, the third aspect, or the possible implementations thereof.

### BRIEF DESCRIPTION OF DRAWINGS

FIG. 1 is a schematic diagram of an application scenario of an energy system according to an embodiment of this application;

FIG. 2 is a schematic diagram of a structure of an energy storage system according to an embodiment of this application;

FIG. 3 is a schematic diagram of a structure of an energy storage system according to another embodiment of this application;

FIG. 4 is a schematic diagram of a structure of an energy storage system according to a third embodiment of this application;

FIG. 5 is an example flowchart of a control method for an energy storage system according to an embodiment of this application;

FIG. 6 is a schematic diagram of a structure of an energy storage system according to a fourth embodiment of this application;

FIG. 7 is an example flowchart of a control method for an energy storage system according to another embodiment of this application;

FIG. 8 is a schematic diagram of a structure of an energy storage system according to a fifth embodiment of this application;

FIG. 9 is an example flowchart of a control method for an energy storage system according to still another embodiment of this application;

FIG. 10 is a schematic diagram of a structure of an energy storage system according to a sixth embodiment of this application;

FIG. 11 is an example flowchart of a control method for an energy storage system at a startup phase according to an embodiment of this application;

FIG. 12A and FIG. 12B are an example flowchart of a control method for an energy storage system at a startup phase according to another embodiment of this application;

FIG. 13A and FIG. 13B are an example flowchart of a control method for an energy storage system at a running phase according to an embodiment of this application; and

FIG. 14 is a schematic diagram of an architecture of an energy system according to an embodiment of this application.

### DESCRIPTION OF EMBODIMENTS

To better describe embodiments of this application, the following first describes related concepts in embodiments of this application.

1. Battery Control Unit (BCU)

The BCU is configured to monitor a voltage, a temperature, a current, and an insulation resistance of a battery string, and control a high-voltage direct current circuit relay and estimation of a state of health (SOH) and a state of charge (SOC) of the battery string.

2. Battery Monitor Unit (BMU)

The BMU is configured to monitor battery physical parameters in real time, estimate a battery status, perform online diagnosis and warning, control charging, discharging, and pre-charging, perform balancing management and heat management, and the like.

3. Energy Management System (EMS)

The EMS is a general name of a modern power grid dispatching automation system (including hardware and software). Main functions of the EMS include basic functions and application functions. The basic functions include a computer, an operating system, and an EMS support system.

The following describes the implementations of embodiments of this application in detail with reference to accompanying drawings.

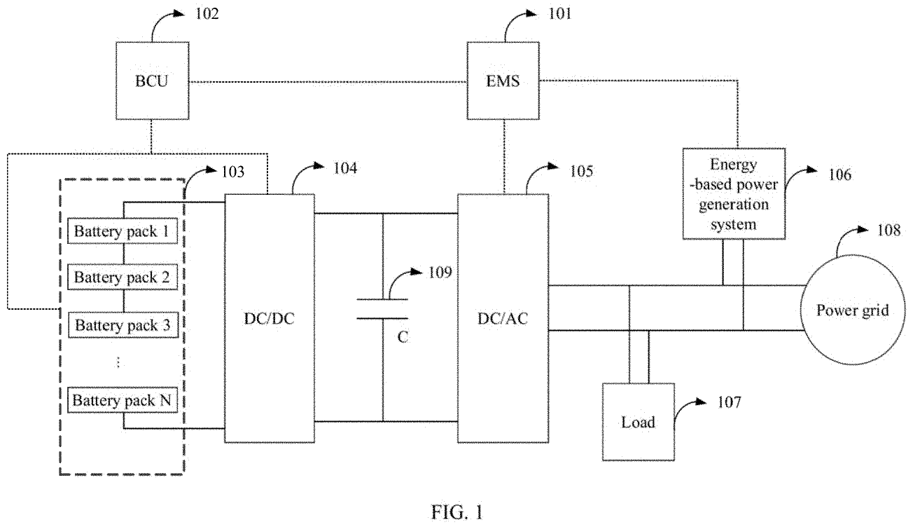

FIG. 1 is a schematic diagram of an application scenario of an energy system according to an embodiment of this application. As shown in FIG. 1, the energy system includes an EMS 101, a BCU 102, an energy storage rack 103, a DC/DC converter 104, a DC/AC converter 105, an energy-based power generation system 106, a load 107, a power grid 108, and a bus capacitor 109. The energy storage rack 103 includes N battery packs connected in series. N is an integer greater than 1.

The energy storage rack 103 is connected to the DC/DC converter 104. The DC/DC converter 104 is connected to the DC/AC converter 105. The DC/AC converter 105 is connected to the load 107 and the power grid 108. The energy-based power generation system is connected to the DC/AC converter 105 on an alternating current side. The EMS 101 is connected to the DC/AC converter 105, the BCU 102, and the energy-based power generation system 106 through a communications cable. The BCU 102 is further connected to the energy storage rack 103 and the DC/DC converter 104 through a communications cable, to implement data transmission.

Optionally, the EMS 101 is specifically configured to determine, based on information about the energy-based power generation system 106, the BCU 102, and the DC/AC converter 105, that the energy storage rack 103 is in a power supply state, a charging state, or a stopped state. The BCU 102 is configured to collect information such as a state of charge (SOC) and a state of health (SOH) of each battery pack in the energy storage rack 103. The energy storage rack 103 may be configured to store electric energy from the energy-based power generation system 106, and may be further configured to supply electric energy to the load 107. The DC/DC converter 104 may implement boost or buck conversion from the energy storage rack 103 to the DC/AC converter 105 side, or may implement boost or buck conversion from the DC/AC converter 105 to the energy storage rack 103 side. A boost circuit structure having a boost function, a BUC circuit structure having a buck function, or a buck or boost circuit structure having both boost and buck functions may be used. When the energy storage rack 103 is charged, the DC/AC converter 105 converts an alternating current of the energy-based power generation system 106 into a direct current that can be stored, or when the load 107 is discharged, converts a direct current of the energy storage rack 103 and that passes through the DC/DC converter 104 into an alternating current that can be used by the load 107. The energy-based power generation system 106 is configured to store electric energy that cannot be consumed in the energy storage rack 103, and is also configured to make power generation of the power grid 108 tend to be stable when power generation is insufficient or power consumption peaks occur. The load 107 is configured to consume electric energy of the energy storage rack 103, or/and electric energy of the power grid 108, or/and electric energy of the energy-based power generation system 106. The power grid 108 is configured to supply power to the load 107. The bus capacitor 109 is configured to perform reactive power compensation, improve line power, and the like.

The energy-based power generation system 106 may be a photovoltaic power generation system, a tidal power generation system, a wind power generation system, or the like. The load 107 may be a power-consuming device such as a motor, a light, or a server. The power grid 108 may be any power supply network.

For example, after the energy system is powered on, the energy storage rack 103 is connected to the bus capacitor 109 by using the DC/DC converter 104, and then the DC/AC converter 105 is connected to the power grid or supplies power to the load. Alternatively, the energy-based power generation system is connected to the DC/AC converter on the alternating current side, and finally charges the energy storage rack 103.

In the conventional technology, the energy storage rack 103 is mainly formed by connecting a plurality of battery packs in series. For example, there are five battery packs, and the five battery packs are connected end to end (electrodes of first and last battery packs are opposite to each other) in sequence. However, because a state of health (SOH) and a state of charge (SOC) of each battery pack are different, some battery packs are fully charged or discharged in advance. However, in a manner of connecting battery packs in series, currents of the battery packs are the same, and a total current usually needs to be limited based on a minimum battery pack current. As a result, a battery with more remaining energy cannot be fully discharged, and a battery pack with less remaining energy cannot be fully charged. In this way, the power backup duration of the energy storage rack 103 is reduced.

To address the problem that the power backup duration of the energy storage rack is short in the conventional technology, embodiments of this application provide an energy storage system and a control method thereof. In the technical solution provided in this application, a switch unit is added to each battery pack in the energy storage rack, and in the operation of the energy system, connection and disconnection of the battery pack are controlled, so that all battery packs are in a synchronous state. In this way, a long power backup duration can be implemented.

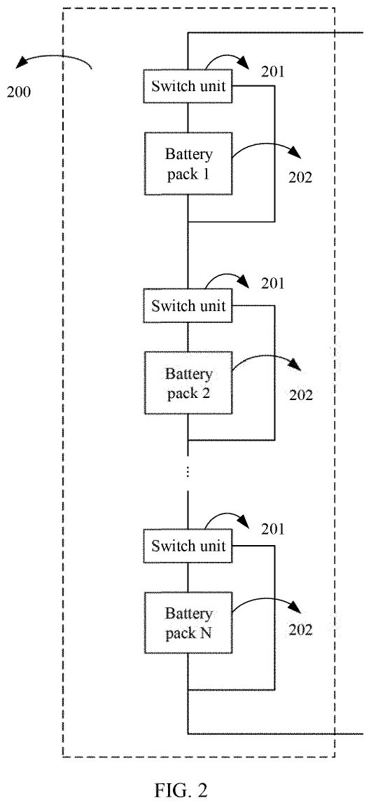

FIG. 2 is a schematic diagram of a structure of an energy storage system according to an embodiment of this application. As shown in FIG. 2, the energy storage system 200 includes N switch units 201 and N battery packs 202 connected in series. The N switch units 201 are separately connected to two ends of the N battery packs 202 in a one-to-one correspondence. N is an integer greater than 1.

Each of the N switch units 201 is configured to: when the energy storage system is in a charging state and the remaining power of a battery pack correspondingly connected to each switch unit meets a first preset condition, and/or when the energy storage system is in a discharging state and the remaining power of the battery pack correspondingly connected to each switch unit meets a second preset condition, perform disconnection processing on the battery pack correspondingly connected to each switch unit.

The first preset condition includes being greater than or equal to a first preset power value. The second preset condition includes being less than or equal to a second preset power value. The first preset power value is greater than the second preset power value. The first preset power value and the second preset power value may be determined based on an SOC and an SCE of the battery pack, or may be determined based on a voltage of the battery pack. The disconnection processing includes disconnecting a current path of the battery pack correspondingly connected to each switch unit and ensuring that a current path of the energy storage system is connected.

In this embodiment, in a process in which the energy storage system performs charging or discharging, a corresponding switch unit is controlled to perform disconnection processing on a battery pack correspondingly connected to the switch unit and that meets the first preset condition or a battery pack correspondingly connected to the switch unit and that meets the second preset condition, and other battery packs continue to be charged or discharged. Finally, all the battery packs reach a same value. When the energy storage system performs charging or discharging again, because the battery energy is the same, a time for completing the charging or discharging is basically the same. In this way, a long power backup duration of the energy storage system can be implemented.

Further, after the battery pack meets the first preset condition or the battery pack meets the second preset condition is off, another battery pack in the energy storage system may still be charged or discharged at a maximum current without being affected by the battery pack being off. In this way, the problem of limited power can be resolved.

For example, the battery pack 202 may include an electrochemical cell, a storage battery, a lithium-ion battery, and the like.

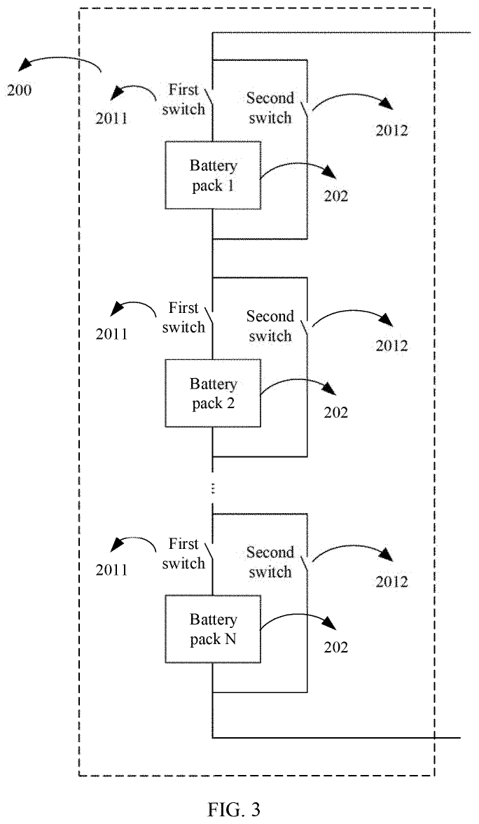

FIG. 3 is a schematic diagram of a structure of an energy storage system according to another embodiment of this application. As shown in FIG. 3, the switch unit 201 may include a first switch 2011 and a second switch 2012. Each of the N battery packs 202 is connected in series to a first switch 2011 in a switch unit 201 correspondingly connected to each battery pack, to obtain a sub-circuit corresponding to each battery pack. A second switch 2012 in the switch unit correspondingly connected to each battery pack is connected in parallel to the sub-circuit corresponding to each battery pack.

When the first switch 2011 is turned off and the second switch 2012 is turned on, the correspondingly connected battery pack 202 may be disconnected from the current path. When the first switch 2011 is turned on and the second switch 2012 is turned off, the correspondingly connected battery pack 202 may be connected to the current path.

For example, the first switch 2011 and the second switch 2012 may be switch components such as relays.

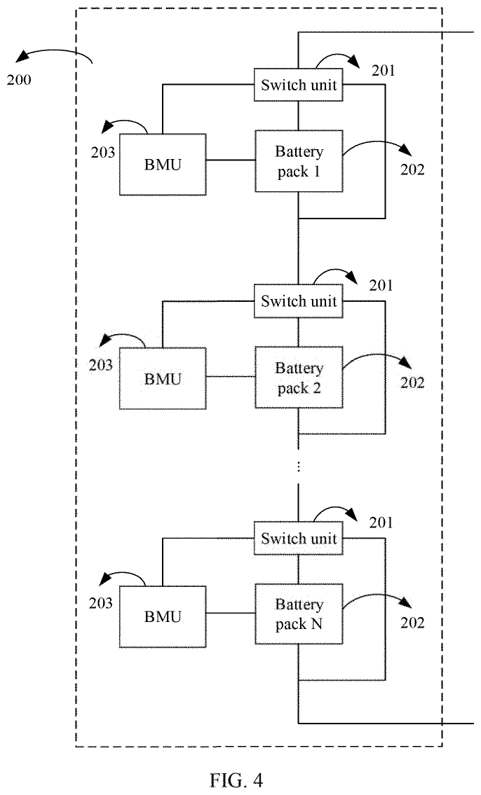

FIG. 4 is a schematic diagram of a structure of an energy storage system according to a third embodiment of this application. As shown in FIG. 4, in addition to the units in the energy storage system shown in FIG. 2, the energy storage system may further include N BMUs 203. The N BMUs 203, the N battery packs 202, and the N switch units 201 are in a one-to-one correspondence with each other.

The BMU may monitor the remaining power of a battery pack correspondingly connected to each BMU, and the BMU may send a control signal to a switch unit correspondingly connected to the BMU.

The switch unit may receive the control signal sent by the correspondingly connected BMU.

The control signal in this embodiment includes: controlling the corresponding switch unit to perform disconnection processing on the battery pack correspondingly connected to the BMU, and/or controlling the corresponding switch unit to perform connection processing on the battery pack correspondingly connected to the BMU. The disconnection processing includes disconnecting a current path of the battery pack correspondingly connected to the switch unit and ensuring that a current path of the energy storage system is connected. The connection processing includes connecting the current path of the battery pack correspondingly connected to the switch unit.

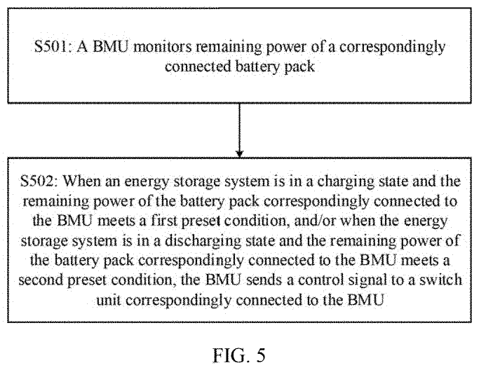

The following describes, with reference to FIG. 5, a control method performed by the BMU in the energy storage system shown in FIG. 4. As shown in FIG. 5, the method may include S501 and S502. The control method may be performed by any BMU in the energy storage system shown in FIG. 4.

S501: ABMU monitors the remaining power of a correspondingly connected battery pack.

S502: When the energy storage system is in a charging state and the remaining power of the battery pack correspondingly connected to the BMU meets a first preset condition, and/or when the energy storage system is in a discharging state and the remaining power of the battery pack correspondingly connected to the BMU meets a second preset condition, the BMU sends a control signal to a switch unit correspondingly connected to the BMU. The control signal is used for controlling the switch unit correspondingly connected to the BMU to perform disconnection processing on the battery pack correspondingly connected to the BMU. The disconnection processing includes disconnecting a current path of a battery pack correspondingly connected to each switch unit and ensuring that a current path of the energy storage system is connected.

According to the control method, in the operation of the energy storage system, disconnection processing is performed on a battery pack that meets the first preset condition or a battery pack that meets the second preset condition, and other battery packs continue to be charged or discharged. Finally, all the battery packs reach a same value. When the energy storage system performs charging or discharging again, because the battery energy is the same, a time for completing the charging or discharging is basically the same. In this way, a long power backup duration of the energy storage system can be implemented.

Optionally, when the energy storage system is in a charging state and the remaining power of all the battery packs meets the first preset condition, and/or when the energy storage system is in a discharging state and the remaining power of all the battery packs meets the second preset condition, a BMU correspondingly connected to a battery pack that is off in the energy storage system sends a control signal to the switch unit correspondingly connected to the BMU. The control signal is used for controlling the switch unit correspondingly connected to the BMU to perform connection processing on the battery pack correspondingly connected to the BMU. The connection processing includes connecting a current path of a battery pack correspondingly connected to each switch unit and ensuring that a current path of the energy storage system is connected.

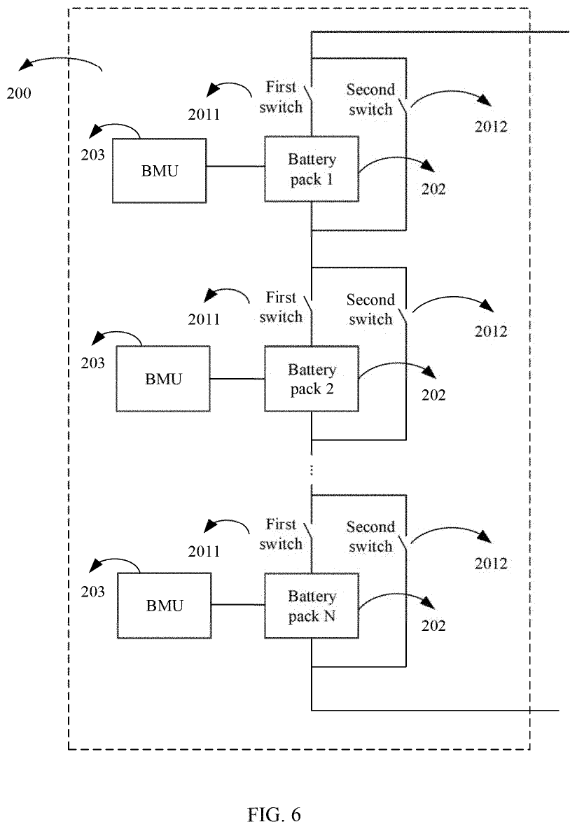

FIG. 6 is a schematic diagram of a structure of an energy storage system according to a fourth embodiment of this application. As shown in FIG. 6, in addition to the units in FIG. 3, the energy storage system may further include N BMUs 203. The N BMUs 203 are separately in a one-to-one correspondence with N battery packs 202, N first switches 2011, and N second switches 2012. Each BMU 203 is separately connected to a first switch 2011 and a second switch 2012 in a switch unit correspondingly connected to each BMU 203.

Each BMU may send a first control signal and a second control signal to the correspondingly connected first switch, and may send the first control signal and the second control signal to the correspondingly connected second switch. The first control signal is a signal that can drive a switch to be turned off, and the second control signal is a signal that can drive a switch to be turned on.

Correspondingly, the first switch may be turned off based on the first control signal and be turned on based on the second control signal, and the second switch may be turned off based on the first control signal and be turned on based on the second control signal.

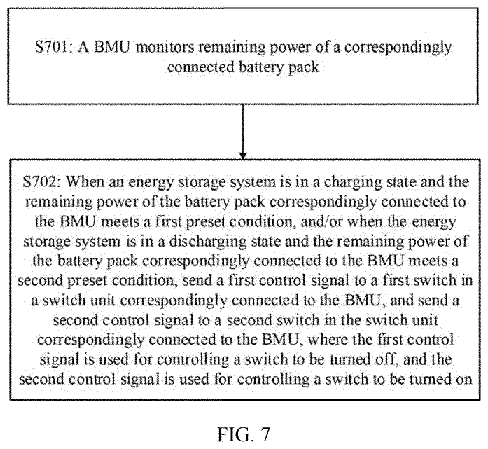

The following describes, with reference to FIG. 7, a control method performed by the BMU in the energy storage system shown in FIG. 6. As shown in FIG. 7, the method may include S701 and S702. The method may be performed by any BMU in the energy storage system shown in FIG. 6.

S701: ABMU monitors the remaining power of a correspondingly connected battery pack.

S702: When the energy storage system is in a charging state and the remaining power of the battery pack correspondingly connected to the BMU meets a first preset condition, and/or when the energy storage system is in a discharging state and the remaining power of the battery pack correspondingly connected to the BMU meets a second preset condition, send a first control signal to a first switch in a switch unit correspondingly connected to the BMU, and send a second control signal to a second switch in the switch unit correspondingly connected to the BMU, where the first control signal is used for controlling a switch to be turned off, and the second control signal is used for controlling a switch to be turned on.

In the method, the first control signal and the second control signal that are sent by the BMU correspondingly connected to each switch unit are received, and a first switch 2011 is controlled to be turned off and a second switch 2012 is controlled to be turned on, to perform disconnection on a battery pack 202 correspondingly connected to the BMU from a current path.

Optionally, when the energy storage system is in a charging state and the remaining power of all battery packs meet the first preset condition, and/or when the energy storage system is in a discharging state and the remaining power of all the battery packs meet the second preset condition, a BMU correspondingly connected to a battery pack that is off in the energy storage system sends the second control signal to the first switch in the switch unit correspondingly connected to the BMU, and sends the first control signal to the second switch in the switch unit correspondingly connected to the BMU. The first control signal is used for controlling the switch to be turned off. The second control signal is used for controlling the switch to be turned on, and performing connection on the battery pack correspondingly connected to the BMU.

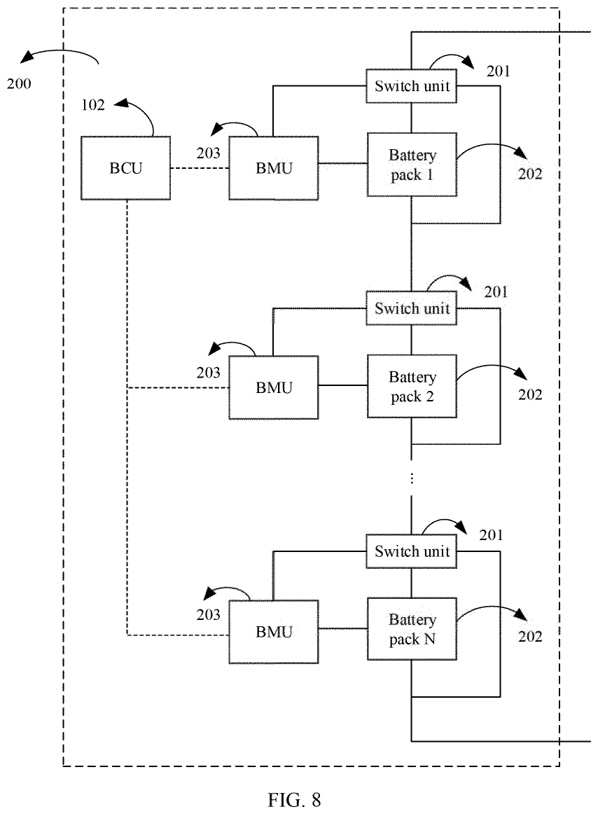

FIG. 8 is a schematic diagram of a structure of an energy storage system according to a fifth embodiment of this application. As shown in FIG. 8, in addition to the units in the energy storage system shown in FIG. 4, the energy storage system may further include a battery control unit BCU 102. The BCU 102 is connected to each BMU 203. The BCU 102 may be connected to the BMU 203 in a wired or wireless manner. The BCU 102 may communicate with each BMU 203.

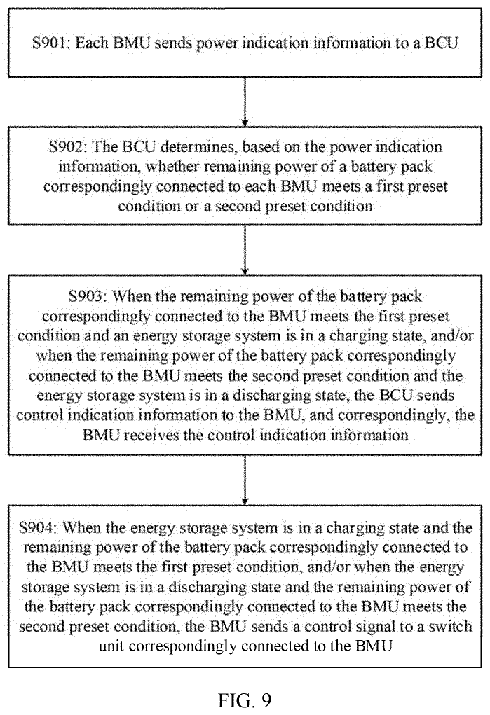

The following describes, with reference to FIG. 9, a control method for the energy storage system shown in FIG. 8. As shown in FIG. 9, the method includes S901, S902, S903, and S904.

S901: Each BMU sends power indication information to a BCU. Correspondingly, the BCU receives the power indication information sent by each BMU.

Each of N BMUs monitors power indication information of a battery pack correspondingly connected to each BMU. The power indication information indicates the remaining power of the battery pack correspondingly connected to the BMU, and then sends the power indication information to the BCU.

S902: The BCU determines, based on the power indication information, whether the remaining power of the battery pack correspondingly connected to each BMU meets a first preset condition or a second preset condition.

The first preset condition includes being greater than or equal to a first preset power value. The second preset condition includes being less than or equal to a second preset power value. The first preset power value is greater than the second preset power value. The first preset power value and the second preset power value may be determined based on an SOC and an SCE of the battery pack, or may be determined based on a voltage of the battery pack.

S903: When the remaining power of the battery pack correspondingly connected to the BMU meets the first preset condition and the energy storage system is in a charging state, and/or when the remaining power of the battery pack correspondingly connected to the BMU meets the second preset condition and the energy storage system is in a discharging state, the BCU sends control indication information to the BMU, and correspondingly, the BMU receives the control indication information.

The control indication information indicates to the BMU to control a correspondingly connected switch unit to perform disconnection processing on the correspondingly connected battery pack. The disconnection processing includes disconnecting a current path of a battery pack correspondingly connected to each switch unit and ensuring that a current path of the energy storage system is connected.

S904: When the energy storage system is in a charging state and the remaining power of the battery pack correspondingly connected to the BMU meets the first preset condition, and/or when the energy storage system is in a discharging state and the remaining power of the battery pack correspondingly connected to the BMU meets the second preset condition, the BMU sends a control signal to the switch unit correspondingly connected to the BMU. The control signal is used for controlling the switch unit correspondingly connected to the BMU to perform disconnection processing on the battery pack correspondingly connected to the BMU. The disconnection processing includes disconnecting the current path of the battery pack correspondingly connected to each switch unit and ensuring that the current path of the energy storage system is connected.

According to the method in this embodiment, the battery control unit BCU performs data communication with each BMU, to more accurately control the energy storage system.

Optionally, when the energy storage system is in a charging state and the remaining power of all battery packs meets the first preset condition, and/or when the energy storage system is in a discharging state and the remaining power of all the battery packs meets the second preset condition, a BMU correspondingly connected to a battery pack that is off in the energy storage system sends the control signal to the switch unit correspondingly connected to the BMU. The control signal is used for controlling the switch unit correspondingly connected to the BMU to perform connection processing on the battery pack correspondingly connected to the BMU. The connection processing includes connecting the current path of the battery pack correspondingly connected to each switch unit and ensuring that the current path of the energy storage system is connected.

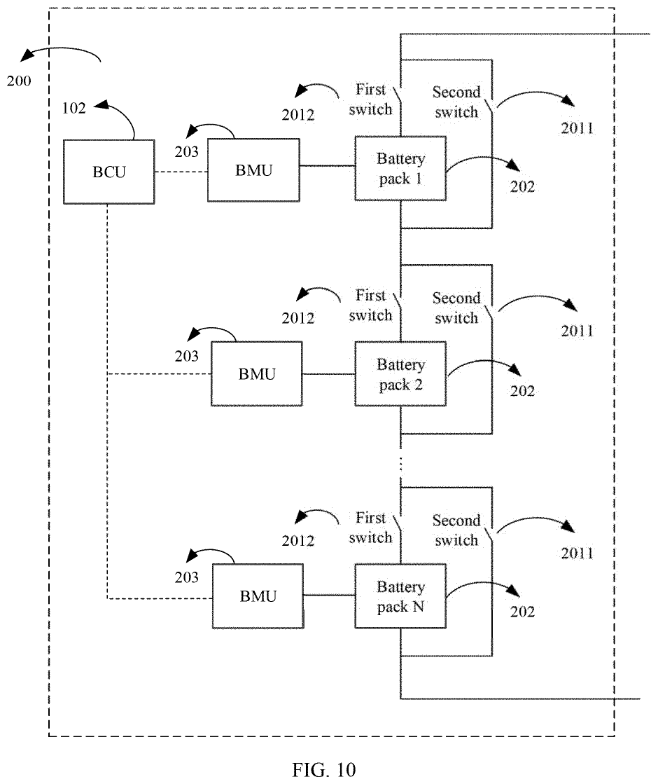

As shown in FIG. 10, in the energy storage system shown in FIG. 8, each switch unit 201 may include a first switch 2011 and a second switch 2012. Each of N battery packs 202 is connected in series to a first switch 2011 in a switch unit 201 correspondingly connected to each battery pack, to obtain a sub-circuit corresponding to each battery pack. A second switch 2012 in the switch unit 201 correspondingly connected to each battery pack is connected in parallel to the sub-circuit corresponding to each battery pack. Each BMU is separately connected to a first switch 2011 and a second switch 2012 in a switch unit 201 correspondingly connected to each BMU.

When each switch unit 201 includes the first switch 2011 and the second switch 2012, that the BMU sends, based on control indication information, a control signal to the correspondingly connected switch unit, to control the switch unit to perform disconnection processing on the correspondingly connected battery pack may include: The BMU sends, based on the control indication information, a first control signal to the first switch in the correspondingly connected switch unit, and sends a second control signal to the second switch in the correspondingly connected switch unit. The first control signal is used for controlling a switch to be turned off. The second control signal is used for controlling a switch to be turned on.

In the method, a BCU sends the control indication information to each BMU. The BMU sends, based on the control indication information, the first control signal to the first switch 2011 in the correspondingly connected switch unit, and sends the second control signal to the second switch 2012 in the correspondingly connected switch unit. The first switch 2011 is controlled to be turned off and the second switch 2012 is controlled to be turned on, to perform disconnection on a battery pack 202 correspondingly connected to the BMU from a current path. In the method, the battery control unit BCU performs data communication with each BMU, to more accurately control of the energy storage system.

When each switch unit 201 includes the first switch 2011 and the second switch 2012, that the BMU sends, based on control indication information, a control signal to the correspondingly connected switch unit, to control the switch unit to perform connection processing on the correspondingly connected battery pack may include: The BMU sends, based on the control indication information, the second control signal to the first switch in the correspondingly connected switch unit, and sends the first control signal to the second switch in the correspondingly connected switch unit.

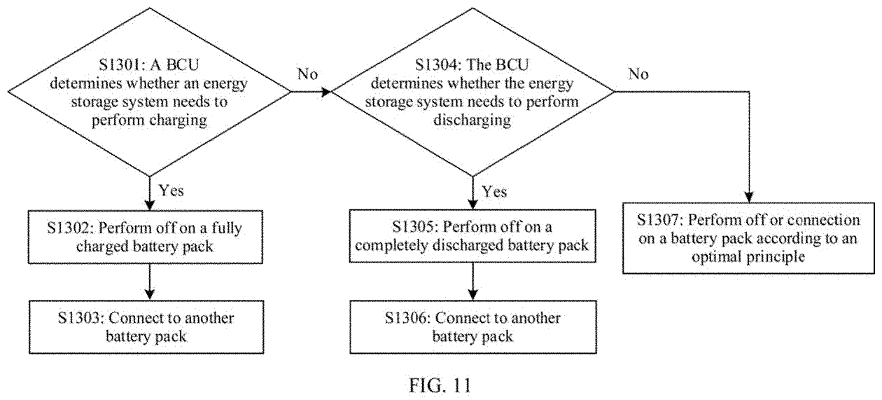

FIG. 11 is an example flowchart of a control method for an energy storage system according to an embodiment of this application. As shown in FIG. 11, the control method may include the following steps: S1301, S1302, S1303, S1304, S1305, S1306, and S1307.

S1301: A BCU determines whether the energy storage system needs to perform charging. If the energy storage system needs to perform charging, S1302 is performed; or if the energy storage system does not need to perform charging, S1304 is performed.

In an example, the BCU determines, within a preset time period after power-on, whether the energy storage system needs to perform charging. In this embodiment, the preset time period during which the BCU is powered on may be referred to as a startup phase of the BCU, and a phase after the startup phase may be referred to as a running phase. Duration of the preset time period may be determined based on the experience of a person skilled in the art, or may be determined based on the response efficiency of the energy storage system.

The BCU determines whether the energy storage system needs to perform charging based on information such as a current value or a current circulation state of the energy storage system. The current circulation state refers to a state in which a current circulates in a specific direction and a specific path.

S1302: Perform disconnection on a fully charged battery pack. Perform disconnection on the fully charged battery pack may be implemented in the following manners.

When the energy storage system needs to perform charging, the BCU sends an instruction to N BMUs. The instruction is used for instructing the BMUs to detect remaining power information of corresponding connected battery packs.

Each BMU sends power indication information to the BCU. The power indication information sent by each BMU indicates the remaining power of a battery pack correspondingly connected to the BMU.

The BCU determines, based on the power indication information sent by each BMU, whether the remaining power of the battery pack correspondingly connected to the BMU meets a first preset condition.

If the remaining power of the battery pack correspondingly connected to the BMU meets the first preset condition, the BCU may determine that the battery pack is a fully charged battery pack, and send first control indication information to the BMU. The first control indication information indicates to the BMU to perform disconnection on the correspondingly connected battery pack. The first preset condition includes being greater than or equal to a first preset power value. The first preset power value may be determined based on an SOC and an SCE of the battery pack, or may be determined based on a voltage of the battery pack.

After receiving the first control indication information, the BMU sends a first control signal to a correspondingly connected first switch, and sends a second control signal to a correspondingly connected second switch.

The first switch that receives the first control signal is turned off, and the second switch that receives the second control signal is turned on. In this way, a current in the energy storage system no longer flows through a corresponding battery pack, but flows to another battery pack through the second switch, so that the corresponding battery pack is removed from a current path of the energy storage system.

It may be understood that, after a battery pack is disconnected from an energy storage rack, the battery pack no longer participates in working, that is, no longer participates in charging, but a working status of another battery pack is not affected.

S1303: Connect to another battery pack. Connecting to another battery pack may be implemented in the following manners.

After detecting the remaining power information of the correspondingly connected battery pack, each BMU sends the remaining power information (that is, the power indication information) of the correspondingly connected battery pack to the BCU. In this case, the BCU may determine, based on the power indication information sent by each BMU, whether the remaining power of the battery pack correspondingly connected to each BMU meets the first preset condition.

If the remaining power of the battery pack correspondingly connected to the BMU does not meet the first preset condition, the BCU may determine that the battery pack is a battery pack that needs to be charged, and send second control indication information to the BMU. The second control indication information indicates to the BMU to perform connection on the corresponding connected battery pack.

After receiving the second control indication information, the BMU sends the second control signal to the correspondingly connected first switch, and sends the first control signal to the correspondingly connected second switch.

The first switch that receives the second control signal is turned on, and the second switch that receives the first control signal is turned off. In this way, a current in the energy storage system flows through a corresponding battery pack, that is, flows to the battery pack through the first switch, so that the corresponding battery pack is connected to the current path of the energy storage system.

Optionally, in this embodiment, a sequence of steps S1302 and S1303 is not limited, and steps S1302 and S1303 may be performed in another sequence.

Further, the system starts charging.

S1304: The BCU determines whether the energy storage system needs to perform discharging. If the energy storage system needs to perform discharging, S1305 is performed; or if the energy storage system does not need to perform discharging, S1307 is performed.

When the BCU is in a startup phase, the BCU determines whether the energy storage system needs to perform discharging based on information such as a current value or a current circulation state of the energy storage system.

S1305: Perform disconnection on a completely discharged battery pack. Perform disconnection on the completely discharged battery pack may be implemented in the following manners.

When the energy storage system needs to perform discharging, the BCU sends an instruction to the N BMUs. The instruction is used for instructing the BMUs to detect remaining power information of the corresponding connected battery packs.

Each BMU sends power indication information to the BCU. The power indication information sent by each BMU indicates the remaining power of the battery pack correspondingly connected to the BMU.

The BCU determines, based on the power indication information sent by each BMU, whether the remaining power of the battery pack correspondingly connected to the BMU meets a second preset condition.

If the remaining power of the battery pack correspondingly connected to the BMU meets the second preset condition, the BCU may determine that the battery pack is a completely discharged battery pack, and send the first control indication information to the BMU. The first control indication information indicates to the BMU to perform disconnection on the correspondingly connected battery pack. The second preset condition includes being less than or equal to a second preset power value. The second preset power value may be determined based on an SOC and an SCE of the battery pack, or may be determined based on a voltage of the battery pack.

After receiving the first control indication information, the BMU sends the first control signal to the correspondingly connected first switch, and sends the second control signal to the correspondingly connected second switch.

The first switch that receives the first control signal is turned off, and the second switch that receives the second control signal is turned on. In this way, the battery pack does not participate in supplying power to a load by the energy storage system, but flows to another battery pack by using the second switch, so that another battery pack supplies power to the load.

It may be understood that, after a battery pack is disconnected from the energy storage rack, the battery pack no longer participates in working, that is, no longer participates in discharging, but a working status of another battery pack is not affected.

S1306: Connect to another battery pack. Connecting to another battery pack may be implemented in the following manners.

After detecting the remaining power information of the correspondingly connected battery pack, each BMU sends the remaining power information (that is, the power indication information) of the correspondingly connected battery pack to the BCU. In this case, the BCU may determine, based on the power indication information sent by each BMU, whether the remaining power of the battery pack correspondingly connected to each BMU meets the second preset condition.

If the remaining power of the battery pack correspondingly connected to the BMU does not meet the second preset condition, the BCU may determine that the battery pack is a battery pack that needs to be discharged, and send the second control indication information to the BMU. The second control indication information indicates to the BMU to perform connection on the corresponding connected battery pack.

After receiving the second control indication information, the BMU sends the second control signal to the correspondingly connected first switch, and sends the first control signal to the correspondingly connected second switch.

The first switch that receives the second control signal is turned on, and the second switch that receives the first control signal is turned off. In this way, a current of the battery pack participates in the energy storage system, that is, flows to the load by using the first switch, so that the correspondingly connected battery pack supplies power to the load, that is, is discharged.

Optionally, in this embodiment, a sequence of steps S1305 and S1306 is not limited, and steps S1305 and S1306 may be performed in another sequence.

Further, the system starts discharging.

S1307: Perform disconnection or connection on a battery pack according to an optimal principle.

When the BCU cannot determine that the energy storage system needs to perform charging or discharging, the BCU determines a status of the battery pack according to an optimal principle.

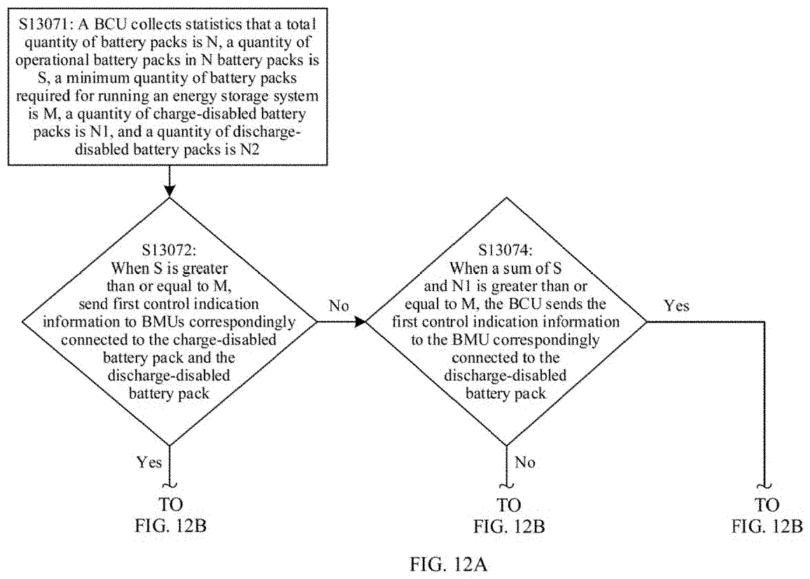

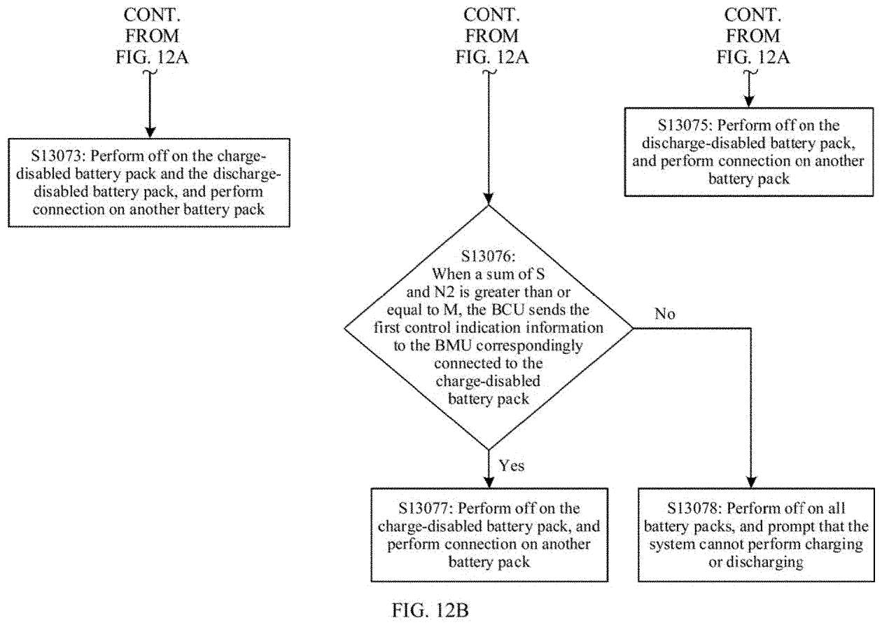

FIG. 12A and FIG. 12B show an example of a control method for performing disconnection or connection on a battery pack according to the optimal principle. The method includes S13071, S13072, S13073, S13074, S13075, S13076, S13077, and S13078.

S13071: The BCU collects statistics that include a total quantity of battery packs is N, a quantity of operational battery packs in N battery packs is S, a minimum quantity of battery packs required for running the energy storage system is M, a quantity of charge-disabled battery packs is N1, and a quantity of discharge-disabled battery packs is N2.

The operational battery packs include battery packs other than a charge-disabled battery pack, a discharge-disabled battery pack, and a faulty battery pack in the energy storage system. The charge-disabled battery pack includes a battery pack whose remaining power is greater than or equal to the first preset power value. The discharge-disabled battery pack includes a battery pack whose remaining power is less than or equal to the second preset power value. The minimum quantity M of battery packs required for running the energy storage system is a value preset by the system.

When the energy storage system needs to perform charging or discharging, the BCU sends an instruction to the N BMUs. The instruction is used for instructing the BMUs to detect remaining power information of the corresponding connected battery packs.

Each BMU sends power indication information to the BCU. The power indication information sent by each BMU indicates the remaining power of the battery pack correspondingly connected to the BMU.

The BCU determines, based on the power indication information sent by each BMU, whether the remaining power of the battery pack correspondingly connected to the BMU is greater than or equal to the first preset power value or is less than or equal to the second preset power value. If the remaining power is greater than or equal to the first preset power value, the battery pack correspondingly connected to the BMU is a charge-disabled battery pack. If the remaining power is less than or equal to the second preset power value, the battery pack correspondingly connected to the BMU is a discharge-disabled battery pack. The first preset condition includes being greater than or equal to the first preset power value. The first preset power value may be determined based on an SOC and an SCE of the battery pack, or may be determined based on a voltage of the battery pack.

S13072: When S is greater than or equal to M, send the first control indication information to BMUs correspondingly connected to the charge-disabled battery pack and the discharge-disabled battery pack, and then perform S13073. When S is less than M, perform S13074.

S13073: Perform disconnection on the charge-disabled battery pack and the discharge-disabled battery pack, and perform connection on another battery pack.

After receiving the first control indication information, the BMU sends the first control signal to first switches correspondingly connected to the charge-disabled battery pack and the discharge-disabled battery pack, and sends the second control signal to second switches correspondingly connected to the charge-disabled battery pack and the discharge-disabled battery pack.

The first switch that receives the first control signal is turned off, and the second switch that receives the second control signal is turned on. In this way, a current in the energy storage system no longer flows through a corresponding battery pack, but flows to another battery pack through the second switch, so that the corresponding battery pack is removed from the current path of the energy storage system.

After receiving the second control indication information, the BMU sends the second control signal to first switches correspondingly connected to battery packs other than the charge-disabled battery pack and the discharge-disabled battery pack in the energy storage system, and sends the first control signal to second switches correspondingly connected to the battery packs other than the charge-disabled battery pack and the discharge-disabled battery pack in the energy storage system.

The first switch that receives the second control signal is turned on, and the second switch that receives the first control signal is turned off. In this way, a current in the energy storage system flows through a corresponding battery pack, that is, flows to the battery pack through the first switch, so that the corresponding battery pack is connected to the current path of the energy storage system.

S13074: When a sum of S and N1 is greater than or equal to M, the BCU sends the first control indication information to the BMU correspondingly connected to the discharge-disabled battery pack, and then performs S13075. When the sum of S and N1 is less than M, performs S13076.

S13075: Perform disconnection on the discharge-disabled battery pack, and perform connection on another battery pack.

After receiving the first control indication information, the BMU sends the first control signal to the first switch correspondingly connected to the discharge-disabled battery pack, and sends the second control signal to the second switch correspondingly connected to the discharge-disabled battery pack.

The first switch that receives the first control signal is turned off, and the second switch that receives the second control signal is turned on. In this way, a current in the energy storage system no longer flows through a corresponding battery pack, but flows to another battery pack through the second switch, so that the corresponding battery pack is removed from the current path of the energy storage system.

After receiving the second control indication information, the BMU sends the second control signal to first switches correspondingly connected to battery packs other than the discharge-disabled battery pack in the energy storage system, and sends the first control signal to second switches correspondingly connected to the battery packs other than the discharge-disabled battery pack in the energy storage system.

The first switch that receives the second control signal is turned on, and the second switch that receives the first control signal is turned off. In this way, a current in the energy storage system flows through a corresponding battery pack, that is, flows to the battery pack through the first switch, so that the corresponding battery pack is connected to the current path of the energy storage system.

S13076: When a sum of S and N2 is greater than or equal to M, the BCU sends the first control indication information to the BMU correspondingly connected to the charge-disabled battery pack, and then performs S13077. When the sum of S and N2 is less than M, performs S13078.

S13077: Perform disconnection on the charge-disabled battery pack, and perform connection on another battery pack.

After receiving the first control indication information, the BMU sends the first control signal to the first switch correspondingly connected to the charge-disabled battery pack, and sends the second control signal to the second switch correspondingly connected to the charge-disabled battery pack.

The first switch that receives the first control signal is turned off, and the second switch that receives the second control signal is turned on. In this way, a current in the energy storage system no longer flows through a corresponding battery pack, but flows to another battery pack through the second switch, so that the corresponding battery pack is removed from the current path of the energy storage system.

After receiving the second control indication information, the BMU sends the second control signal to first switches correspondingly connected to battery packs other than the charge-disabled battery pack in the energy storage system, and sends the first control signal to second switches correspondingly connected to the battery packs other than the charge-disabled battery pack in the energy storage system.

The first switch that receives the second control signal is turned on, and the second switch that receives the first control signal is turned off. In this way, a current in the energy storage system flows through a corresponding battery pack, that is, flows to the battery pack through the first switch, so that the corresponding battery pack is connected to the current path of the energy storage system.

Optionally, in this embodiment, a sequence of steps S13074 and S13076 is not limited, and steps S13074 and S13076 may be performed in another sequence.

S13078: Perform disconnection on all battery packs, and prompt that the system cannot perform charging or discharging.

When the foregoing conditions cannot be met, the BCU sends the second control indication information to the N BMUs. After receiving the second control indication information, the BMU sends the second control signal to first switches correspondingly connected to all of the battery packs in the energy storage system, and sends the first control signal to second switches correspondingly connected to all of the battery packs in the energy storage system.

The first switch that receives the second control signal is turned on, and the second switch that receives the first control signal is turned off. In this way, a current in the energy storage system flows through a corresponding battery pack, that is, flows to the battery pack through the first switch, so that the corresponding battery pack is connected to the current path of the energy storage system. Then, the BCU sends prompt information to the EMS, and the prompt information is displayed on an interface of an EMS, to notify a user that the energy storage system cannot perform charging or discharging.

According to the control method provided in this embodiment of this application, at a startup phase of the energy storage system, a corresponding charge-disabled battery pack or discharge-disabled battery pack is off based on a charge/discharge requirement of the system, to support system startup. If the charge/discharge requirement of the system is not clear, the system can be started based on a preset startup sequence to implement diversified startup. In addition, when a battery is abnormal, the battery can be off without affecting the operation of other battery packs.

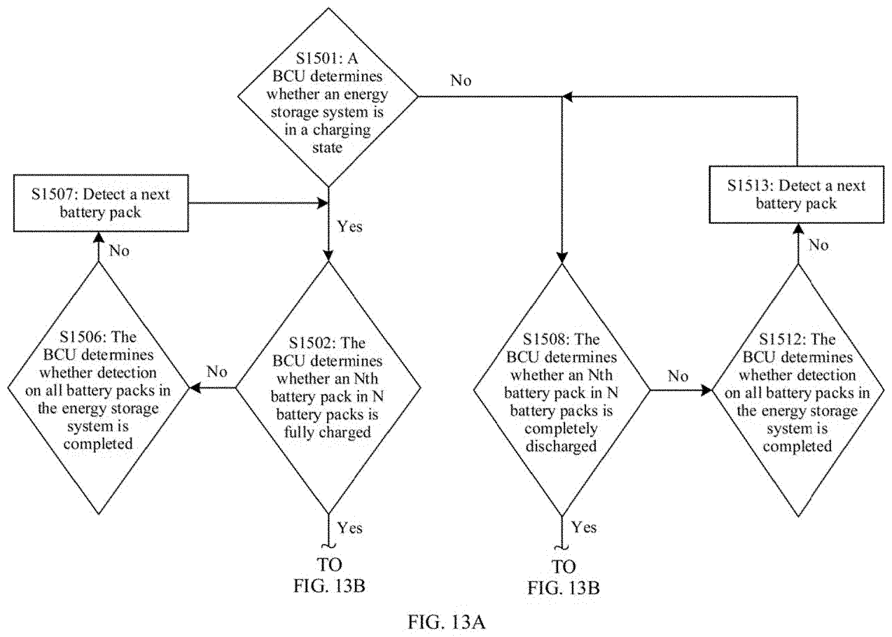

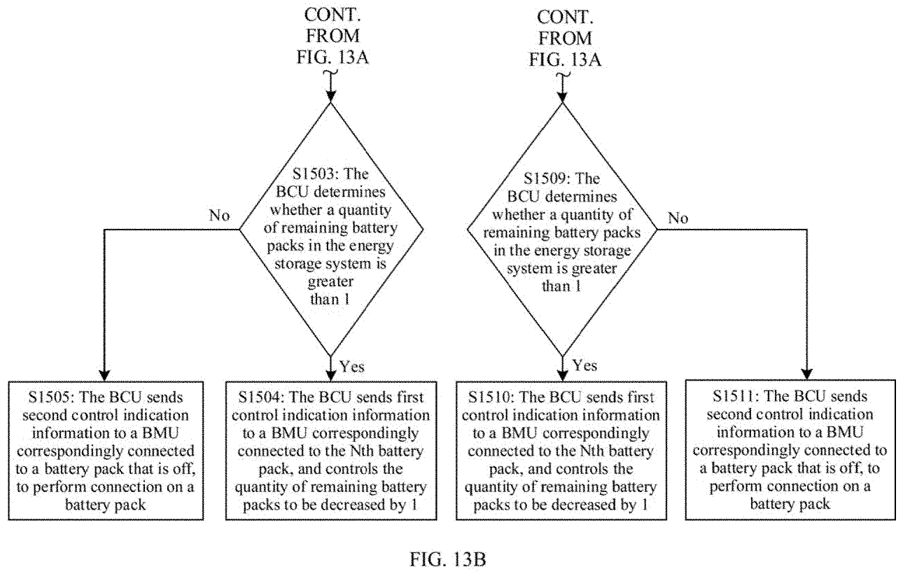

FIG. 13A and FIG. 13B are an example flowchart of a control method for an energy storage system at a running phase according to an embodiment of this application. The method is performed by a BCU, and may specifically include the following steps: S1501, S1502, S1503, S1504, S1505, S1506, S1507, S1508, S1509, S1510, S1511, S1512, and S1513.

After a startup phase of the energy storage system is complete, the energy storage system enters the running phase.

S1501: The BCU determines whether the energy storage system is in a charging state.

At the running phase of the energy storage system, the BCU determines, based on information such as a current value, a flow direction of the current, a voltage value, and a change of battery pack capacity in a current path in the operation of the energy storage system, whether the energy storage system is in a charging state at this time. If the energy storage system is in the charging state, perform S1502. If the energy storage system is not in the charging state, perform S1508.

S1502: The BCU determines whether an Nth battery pack in N battery packs is fully charged.

In a charging process of the energy storage system, the BCU sends an instruction to a correspondingly connected BMU of the Nth battery pack. The instruction is used for instructing the BMU to detect remaining power information of the correspondingly connected battery pack.

The BMU correspondingly connected to the Nth battery pack sends power indication information to the BCU. The power indication information indicates the remaining power of the battery pack correspondingly connected to the BMU.

The BCU determines, based on the power indication information sent by the BMU, whether the remaining power of the Nth battery pack correspondingly connected to the BMU meets a first preset condition. If the remaining power of the Nth battery pack correspondingly connected to the BMU meets the first preset condition, the BCU may determine that the battery pack is a fully charged battery pack, and then perform S1503. If the remaining power of the Nth battery pack correspondingly connected to the BMU does not meet the first preset condition, perform S1506. The first preset condition includes being greater than or equal to a first preset power value. The first preset power value may be determined based on an SOC and an SCE of the battery pack, or may be determined based on a voltage of the battery pack.

S1503: The BCU determines whether a quantity of remaining battery packs in the energy storage system is greater than 1.

If the Nth battery pack in the N battery packs is fully charged, the BCU determines whether a quantity of remaining battery packs in the N battery packs is greater than 1. If the quantity of remaining battery packs in the N battery packs is greater than 1, perform S1504. If the quantity of remaining battery packs in the N battery packs is not greater than 1, perform S1505.

S1504: The BCU sends first control indication information to a BMU correspondingly connected to the Nth battery pack, and controls the quantity of remaining battery packs to be decreased by 1.

The BCU sends the first control indication information to the BMU correspondingly connected to the Nth battery pack. The first control indication information indicates to the BMU to perform disconnection on the correspondingly connected Nth battery pack. After receiving the first control indication information, the BMU sends a first control signal to a correspondingly connected first switch, and sends a second control signal to a correspondingly connected second switch.

The first switch that receives the first control signal is turned off, and the second switch that receives the second control signal is turned on. In this way, a current in the energy storage system no longer flows through a corresponding battery pack, but flows to another battery pack through the second switch, so that the corresponding battery pack is removed from the current path of the energy storage system.

The BCU controls the quantity of remaining battery packs in the energy storage system to be decreased by 1.

For example, if two battery packs remain after the quantity of remaining battery packs in the energy storage system is decreased by 1, that is, the quantity of remaining battery packs is still greater than 1, the execution may end, and the determining may be performed again from S1501. Alternatively, return to perform S1502 and perform next determining.

S1505: The BCU sends second control indication information to a BMU correspondingly connected to a battery pack that is off, to perform connection on a battery pack.

If the BCU determines that the quantity of remaining battery packs in the energy storage system is 1, the BCU sends the second control indication information to the BMU correspondingly connected to the battery pack that is off. The second control indication information indicates to the BMU to perform connection on the corresponding connected battery pack.

After receiving the second control indication information, the BMU sends the second control signal to the correspondingly connected first switch, and sends the first control signal to the correspondingly connected second switch.

The first switch that receives the second control signal is turned on, and the second switch that receives the first control signal is turned off. In this way, a current in the energy storage system flows through a corresponding battery pack, that is, flows to the battery pack through the first switch, so that the corresponding battery pack is connected to the current path of the energy storage system.

Optionally, battery packs that are off may be reconnected one by one, or a plurality or all of the battery packs that are off can be reconnected at a time.

S1506: The BCU determines whether detection on all battery packs in the energy storage system is completed.

The BCU determines whether detection on all the battery packs in the energy storage system is completed. If detection is completed, end execution. If detection is not completed, perform S1507.

S1507: Detect a next battery pack.

S1508: The BCU determines whether an Nth battery pack in N battery packs is completely discharged.

In a discharging process of the energy storage system, the BCU sends an instruction to the correspondingly connected BMU of the Nth battery pack. The instruction is used for instructing the BMU to detect the remaining power information of the correspondingly connected battery pack.

The BMU correspondingly connected to the Nth battery pack sends the power indication information to the BCU. The power indication information indicates the remaining power of the battery pack correspondingly connected to the BMU.

The BCU determines, based on the power indication information sent by the BMU, whether the remaining power of the Nth battery pack correspondingly connected to the BMU meets a second preset condition. If the remaining power of the Nth battery pack correspondingly connected to the BMU meets the second preset condition, the BCU may determine that the battery pack is a completely discharged battery pack, and then perform S1509. If the remaining power of the Nth battery pack correspondingly connected to the BMU does not meet the second preset condition, perform S1512. The second preset condition includes being less than or equal to a second preset power value. The second preset power value may be determined based on an SOC and an SCE of the battery pack, or may be determined based on a voltage of the battery pack.

S1509: The BCU determines whether a quantity of remaining battery packs in the energy storage system is greater than 1.

If the Nth battery pack in the N battery packs is fully charged, the BCU determines whether the quantity of remaining battery packs in the N battery packs is greater than 1. If the quantity of remaining battery packs in the N battery packs is greater than 1, perform S1510. If the quantity of remaining battery packs in the N battery packs is not greater than 1, perform S1511.

S1510: The BCU sends first control indication information to a BMU correspondingly connected to the Nth battery pack, and controls the quantity of remaining battery packs to be decreased by 1.

The BCU sends the first control indication information to the BMU correspondingly connected to the Nth battery pack. The first control indication information indicates to the BMU to perform disconnection on the correspondingly connected Nth battery pack. After receiving the first control indication information, the BMU sends the first control signal to the correspondingly connected first switch, and sends the second control signal to the correspondingly connected second switch.

The first switch that receives the first control signal is turned off, and the second switch that receives the second control signal is turned on. In this way, a current in the energy storage system no longer flows through a corresponding battery pack, but flows to another battery pack through the second switch, so that the corresponding battery pack is removed from the current path of the energy storage system.

The BCU controls the quantity of remaining battery packs in the energy storage system to be decreased by 1.

For example, if two battery packs remain after the quantity of remaining battery packs in the energy storage system is decreased by 1, that is, the quantity of remaining battery packs is still greater than 1, the execution may end, and the determining may be performed again from S1501. Alternatively, return to perform S1508 and perform next determining.

S1511: The BCU sends second control indication information to a BMU correspondingly connected to a battery pack that is off, to perform connection on a battery pack.

If the BCU determines that the quantity of remaining battery packs in the energy storage system is 1, the BCU sends the second control indication information to the BMU correspondingly connected to the battery pack that is off. The second control indication information indicates to the BMU to perform connection on the corresponding connected battery pack.

After receiving the second control indication information, the BMU sends the second control signal to the correspondingly connected first switch, and sends the first control signal to the correspondingly connected second switch.

The first switch that receives the second control signal is turned on, and the second switch that receives the first control signal is turned off. In this way, a current in the energy storage system flows through a corresponding battery pack, that is, flows to the battery pack through the first switch, so that the corresponding battery pack is connected to the current path of the energy storage system.

Optionally, battery packs that are off may be connected one by one, or a plurality or all of the battery packs that are off can be connected at a time.

S1512: The BCU determines whether detection on all battery packs in the energy storage system is completed.

The BCU determines whether detection on all the battery packs in the energy storage system is completed. If detection is completed, end execution. If detection is not completed, perform S1513.

S1513: Detect a next battery pack.

After the foregoing processing on the battery pack N ends, a status of the next battery pack is detected, whether discharging of the battery pack is completed is determined, and the foregoing process is repeated.

Optionally, when a battery pack is disconnected or connected in a process of running, the battery pack may be disconnected or connected online, and a DC/DC converter continues to run. Alternatively, the battery pack may be disconnected or connected offline. The DC/DC converter first stops operating or shuts down, and then continues to run after the battery pack is connected or disconnected.

Optionally, when the battery pack is disconnected or connected, a current instruction may be first reduced, and then an action of connection or disconnection is performed.

At the running phase of the energy storage system, a fully charged or completely discharged battery pack is off, and other battery packs continue to be charged and discharged. Finally, all the battery packs reach a same value. Then, when the energy storage system performs charging or discharging again, energy of the battery packs is the same. In this way, a long power backup duration of the energy storage system can be implemented. In addition, after the fully charged or completely discharged battery pack is off, another battery pack in the energy storage system may still be charged or discharged at a maximum current without being affected by disconnection of the battery pack. In this way, a problem that power is limited can be resolved.

In this embodiment of this application, that the BCU sends an instruction to the BMU to control connection or disconnection of the battery pack is merely an example. This application is not limited thereto. For example, an EMS may alternatively be used for performing all or a part of the operations performed by the BCU in the foregoing method embodiments.

In this embodiment of this application, a method for controlling, by using the first switch and the second switch, a battery pack to be connected to or disconnected from the N battery packs connected in series is merely an example. The method for performing connection or disconnection on a battery pack in this application is not limited thereto.

Optionally, the energy storage system in this embodiment may further include a DC/DC converter. An input port (or referred to as an output port) of the DC/DC converter is connected to two ports of an energy storage rack that includes the N battery packs, and may receive a signal sent by the BCU.

Optionally, the energy storage system in this embodiment may further include a bus capacitor. The bus capacitor is connected to an output port (different from the port connected to the energy storage rack) of the DC/DC converter. Optionally, the energy storage system in this embodiment may further include a DC/AC converter. A port on one side of the DC/AC converter is connected to the bus capacitor, and a port on the other side is configured to connect to a power grid, a power generation system, or a load.

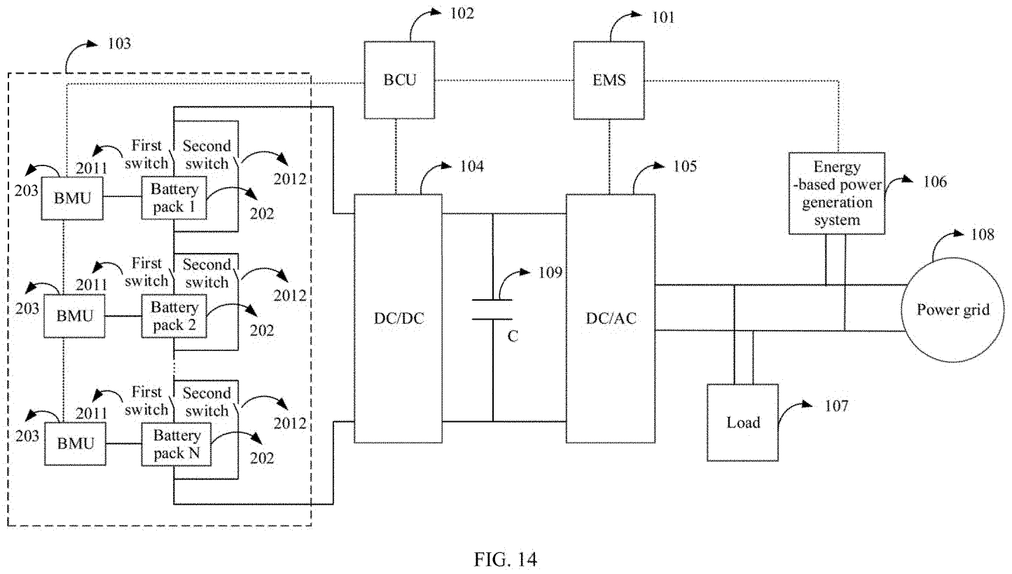

FIG. 14 is a schematic diagram of an architecture of an energy system according to an embodiment of this application. As shown in FIG. 14, the energy system includes an EMS 101, a BCU 102, an energy storage rack 103, a DC/DC converter 104, a DC/AC converter 105, an energy-based power generation system 106, a load 107, a power grid 108, and a bus capacitor 109. The energy storage rack 103 includes N first switches 2011, N second switches 2012, N BMUs 203, and N battery packs 202 connected in series. The N battery packs 202 are separately in a one-to-one correspondence with the N first switches 2011, the N second switches 2012, and the N BMUs 203. N is an integer greater than 1.

For related content of each unit in this embodiment, reference may be made to related content of a unit with a same reference sign in the accompanying drawings in any one of the foregoing embodiments. Details are not described herein again.

It may be understood that all or a part of the foregoing embodiments may be implemented by using software, hardware, firmware, or any combination thereof. When the software is used to implement the embodiments, all or a part of the foregoing embodiments may be implemented in a form of a computer program product. The computer program product includes one or more computer instructions or computer programs. When the program instructions or the computer programs are loaded and executed on a computer, the procedure or functions according to embodiments of this application are all or partially generated. The computer may be a general-purpose computer, a dedicated computer, a computer network, or other programmable apparatuses. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, infrared, radio, and microwave, or the like) manner. The computer-readable storage medium may be any usable medium accessible by the computer, or a data storage device, such as a server or a data center that integrates one or more usable media. The usable medium may be a magnetic medium (for example, a floppy disk, a hard disk, or a magnetic tape), an optical medium (for example, a DVD), or a semiconductor medium. The semiconductor medium may be a solid-state drive.

It should be understood that the term “and/or” in this specification describes only an association relationship between associated objects and indicates that three relationships may exist. For example, A and/or B may indicate the following three cases: only A exists, both A and B exist, and only B exists. A and B may be singular or plural. In addition, the character “/” in this specification usually represents an “or” relationship between the associated objects, or may indicate an “and/or” relationship. A specific meaning depends on a context.

In this application, “at least one” means one or more, and “a plurality of” means two or more. At least one of the following items (pieces) or a similar expression thereof refers to any combination of these items, including any combination of singular items (pieces) or plural items (pieces). For example, at least one item (piece) of a, b, and c may indicate: a, b, c, a and b, a and c, b and c, or a, b, and c, where a, b, and c may be singular or plural.

It should be understood that sequence numbers of the foregoing processes do not mean execution sequences in embodiments of this application. The execution sequences of the processes should be determined based on functions and internal logic of the processes, and should not constitute any limitation on implementation processes of embodiments of this application.

A person of ordinary skill in the art may be aware that, in combination with the examples described in embodiments disclosed in this specification, units and algorithm steps may be implemented by electronic hardware or a combination of computer software and electronic hardware. Whether the functions are performed by using hardware or software depends on particular applications and design constraints of the technical solutions. A person skilled in the art may use different methods to implement the described functions for each particular application, but it should not be considered that the implementation goes beyond the scope of this application.

A person skilled in the art may clearly understand that, for the purpose of convenient and brief description, for detailed working processes of the foregoing system, apparatus, and unit, refer to corresponding processes in the foregoing method embodiments. Details are not described herein again.

In the several embodiments provided in this application, it should be understood that the disclosed system, apparatus, and method may be implemented in other manners. For example, the foregoing apparatus embodiments are merely examples. For example, division into the units is merely logical function division and may be other division in actual implementation. For example, a plurality of units or components may be combined or integrated into another system, or some features may be ignored or not performed. In addition, the displayed or discussed mutual couplings or direct couplings or communications connections may be implemented through some interfaces. The indirect couplings or communications connections between the apparatuses or units may be implemented in electronic, mechanical, or another form.

The units described as separate parts may or may not be physically separate, and parts displayed as units may or may not be physical units, that is, may be located in one position, or may be distributed on a plurality of network units. A part or all of the units may be selected based on actual requirements to achieve the objectives of the solutions of embodiments.

In addition, functional units in embodiments of this application may be integrated into one processing unit, or each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions in this application essentially, or the part contributing to a conventional technology, or the part of the technical solutions may be implemented in a form of a software product. The computer software product is stored in a storage medium, and includes several instructions for instructing a computer device (which may be a personal computer, a server, a network device, or the like) to perform all or a part of the steps of the methods in embodiments of this application. The foregoing storage medium includes any medium that can store program code, such as a USB flash drive, a removable hard disk, a read-only memory, a random access memory, a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. An energy storage system comprising:
N switch units and N battery packs connected in series, the N switch units separately connected to two ends of the N battery packs in a one-to-one correspondence, where N is an integer greater than 1, wherein
each of the N switch units is configured to: when the energy storage system is in a charging state and a remaining power of a battery pack correspondingly connected to each switch unit meets a first preset condition, and/or when the energy storage system is in a discharging state and the remaining power of the battery pack correspondingly connected to each switch unit meets a second preset condition, perform disconnection processing on the battery pack correspondingly connected to each switch unit, wherein the first preset condition comprises that the remaining power of the battery pack correspondingly connected to each switch unit being greater than or equal to a first preset power value, wherein the disconnection processing comprises disconnecting a current path of the battery pack correspondingly connected to each switch unit and ensuring that a current path of the energy storage system is connected, wherein the second preset condition comprises being less than or equal to a second preset power value, and the first preset power value is greater than the second preset power value.

2. The energy storage system according to claim 1, wherein the energy storage system further comprises N battery monitor units (BMUs), and the N BMUs, the N battery packs, and the N switch units are in a one-to-one correspondence with each other, wherein
each of the N BMUs is configured to: monitor a remaining power of a battery pack correspondingly connected to each BMU, and when the energy storage system is in a charging state and the remaining power of the battery pack correspondingly connected to each BMU meets the first preset condition, and/or when the energy storage system is in a discharging state and the remaining power of the battery pack correspondingly connected to each BMU meets the second preset condition, send a first control signal to a switch unit correspondingly connected to each BMU, wherein the first control signal controls the switch unit correspondingly connected to each BMU to perform the disconnection processing on the battery pack correspondingly connected to each BMU; and
each switch unit is configured to: receive the first control signal sent by the BMU correspondingly connected to each switch unit, and perform, under control of the first control signal, the disconnection processing on the battery pack correspondingly connected to each switch unit.

3. The energy storage system according to claim 2, wherein each of the N switch units comprises a first switch and a second switch, wherein
each of the N battery packs is connected in series to a first switch in a switch unit correspondingly connected to each battery pack, to obtain a sub-circuit corresponding to each battery pack, a second switch in the switch unit correspondingly connected to each battery pack is connected in parallel to the sub-circuit corresponding to each battery pack, and each BMU is separately connected to a first switch and a second switch in the switch unit correspondingly connected to each BMU;
each BMU is specifically configured to: when the energy storage system is in a charging state and the remaining power of the battery pack correspondingly connected to each BMU meets the first preset condition, and/or when the energy storage system is in a discharging state and the remaining power of the battery pack correspondingly connected to each BMU meets the second preset condition, send a second control signal to the first switch in the switch unit correspondingly connected to each BMU, and send a third control signal to the second switch in the switch unit correspondingly connected to each BMU, wherein the second control signal is used for controlling a switch to be turned off, and the third control signal is used for controlling a switch to be turned on;
the first switch in each switch unit is configured to: receive the second control signal sent by the BMU correspondingly connected to each switch unit, and be turned off under control of the second control signal; and
the second switch in each switch unit is configured to: receive the third control signal sent by the BMU correspondingly connected to each switch unit, and be turned on under control of the third control signal.

4. The energy storage system according to claim 3, wherein the energy storage system further comprises a battery control unit (BCU), and the BCU is connected to each BMU, wherein
each BMU is further configured to: send power indication information corresponding to each BMU to the BCU, wherein the power indication information indicates the remaining power of the battery pack correspondingly connected to each BMU;
the BCU is configured to: receive the power indication information sent by each BMU, and determine, based on the power indication information, whether the remaining power of the battery pack correspondingly connected to each BMU meets the first preset condition or the second preset condition, when the remaining power of the battery pack correspondingly connected to each BMU meets the first preset condition and the energy storage system is in a charging state, and/or when the remaining power of the battery pack correspondingly connected to each BMU meets the second preset condition and the energy storage system is in a discharging state, send control indication information to each BMU, wherein the control indication information indicates to the BMU to control the correspondingly connected switch unit to perform disconnection processing on the correspondingly connected battery pack; and
each BMU is configured to: receive the control indication information sent by the BCU, and send, based on the control indication information, the second control signal to the first switch in the switch unit correspondingly connected to each BMU, and send the third control signal to the second switch in the switch unit correspondingly connected to each BMU.

5. The energy storage system according to claim 4, wherein the BCU is further configured to: determine, at a startup phase of the BCU, whether the energy storage system needs to perform charging, and when the energy storage system needs to perform charging, send the control indication information to a BMU correspondingly connected to a charge-disabled battery pack in the N battery packs, wherein the charge-disabled battery pack comprises a battery pack whose remaining power is greater than or equal to the first preset power value.

6. The energy storage system according to claim 4, wherein the BCU is further configured to: determine, at a startup phase of the BCU, whether the energy storage system needs to perform discharging, and when the energy storage system needs to perform discharging, send the control indication information to a BMU correspondingly connected to a discharge-disabled battery pack in the N battery packs, wherein the discharge-disabled battery pack comprises a battery pack whose remaining power is less than or equal to the second preset power value.

7. The energy storage system according to claim 4, wherein the BCU is further configured to: determine, at a startup phase of the BCU, whether the energy storage system needs to perform charging and whether the energy storage system needs to perform discharging, and when the energy storage system does not need to perform charging and does not need to perform discharging, determine whether a quantity S of operational battery packs in the N battery packs is greater than or equal to a minimum quantity M of battery packs required for running the energy storage system, wherein the operational battery packs comprise battery packs other than any charge-disabled battery packs, any discharge-disabled battery packs, and any faulty battery packs in the energy storage system; wherein a charge-disabled battery pack comprises a battery pack whose remaining power is greater than or equal to the first preset power value, and a discharge-disabled battery pack comprises a battery pack whose remaining power is less than or equal to the second preset power value; and
the BCU is further configured to: when S is greater than or equal to M, send the control indication information to BMUs correspondingly connected to any charge-disabled battery packs and any discharge-disabled battery packs.

8. The energy storage system according to claim 7, wherein the BCU is further configured to: when S is less than M, determine whether a sum of S and a quantity N1 of charge-disabled battery packs in the energy storage system is greater than or equal to M, and when the sum of S and N1 is greater than or equal to M, send the control indication information to the BMU correspondingly connected to the N1 discharge-disabled battery packs.

9. The energy storage system according to claim 7, wherein the BCU is further configured to: when S is less than M, determine whether a sum of S and a quantity N2 of discharge-disabled battery packs in the energy storage system is greater than or equal to M, and when the sum of S and N2 is greater than or equal to M, send the control indication information to the BMU correspondingly connected to the N2 charge-disabled battery packs.

10. A control method for an energy storage system, wherein the energy storage system comprises a battery control unit (BCU), N battery monitor units (BMUs), N switch units, and N battery packs connected in series, the N BMUs, the N battery packs, and the N switch units are in a one-to-one correspondence with each other, N is an integer greater than 1, and the control method comprises:
receiving, by the BCU, power indication information sent by each BMU;
determining, by the BCU based on the power indication information, whether a remaining power of a battery pack correspondingly connected to each BMU meets a first preset condition or a second preset condition; and
when the remaining power of the battery pack correspondingly connected to each BMU meets the first preset condition and the energy storage system is in a charging state, and/or when the remaining power of the battery pack correspondingly connected to each BMU meets the second preset condition and the energy storage system is in a discharging state, sending, by the BCU, control indication information to each BMU, wherein the power indication information indicates the remaining power of the battery pack correspondingly connected to each BMU, wherein the control indication information indicates the BMU to control a correspondingly connected switch unit to perform disconnection processing on the correspondingly connected battery pack, wherein the disconnection processing comprises disconnecting a current path of a battery pack correspondingly connected to each switch unit and ensuring that a current path of the energy storage system is connected.

11. The control method according to claim 10, wherein the method further comprises:
determining, by the BCU at a startup phase of the BCU, whether the energy storage system needs to perform charging; and
when the energy storage system needs to perform charging, sending, by the BCU, the control indication information to a BMU correspondingly connected to a charge-disabled battery pack in the N battery packs, wherein the charge-disabled battery pack comprises a battery pack whose remaining power is greater than or equal to a first preset power value.

12. The control method according to claim 10, wherein the method further comprises:
determining, by the BCU at a startup phase of the BCU, whether the energy storage system needs to perform discharging; and
when the energy storage system needs to perform discharging, sending, by the BCU, the control indication information to a BMU correspondingly connected to a discharge-disabled battery pack in the N battery packs, wherein the discharge-disabled battery pack comprises a battery pack whose remaining power is less than or equal to a second preset power value.

13. The control method according to claim 10, wherein the method further comprises:
determining, by the BCU at a startup phase of the BCU, whether the energy storage system needs to perform charging and whether the energy storage system needs to perform discharging;
when the energy storage system does not need to perform charging and does not need to perform discharging, determining, by the BCU, whether a quantity S of operational battery packs in the N battery packs is greater than or equal to a minimum quantity M of battery packs required for running the energy storage system, wherein the operational battery packs comprise battery packs other than any charge-disabled battery packs, any discharge-disabled battery packs, and any faulty battery packs in the energy storage system; wherein a charge-disabled battery pack comprises a battery pack whose remaining power is greater than or equal to the first preset power value, and a discharge-disabled battery pack comprises a battery pack whose remaining power is less than or equal to the second preset power value; and
when S is greater than or equal to M, sending, by the BCU, the control indication information to BMUs correspondingly connected to any charge-disabled battery pack and any discharge-disabled battery pack.

14. The control method according to claim 13, wherein the method further comprises:
when S is less than M, determining, by the BCU, whether a sum of S and a quantity N1 of charge-disabled battery packs in the energy storage system is greater than or equal to M; and
when the sum of S and N1 is greater than or equal to M, sending, by the BCU, the control indication information to the BMU correspondingly connected to the N1 discharge-disabled battery packs.

15. The control method according to claim 13, wherein the method further comprises:
when S is less than M, determining, by the BCU, whether a sum of S and a quantity N2 of discharge-disabled battery packs in the energy storage system is greater than or equal to M; and
when the sum of S and N2 is greater than or equal to M, sending, by the BCU, the control indication information to the BMU correspondingly connected to the N2 charge-disabled battery packs.

16. A control method for an energy storage system, wherein the energy storage system comprises N battery monitor units BMUs, N switch units, and N battery packs connected in series, the N BMUs, the N battery packs, and the N switch units are in a one-to-one correspondence with each other, N is an integer greater than 1, and the control method comprises:
monitoring, by each of the N BMUs, a remaining power of a battery pack correspondingly connected to each BMU; and
when the energy storage system is in a charging state and the remaining power of the battery pack correspondingly connected to each BMU meets a first preset condition, and/or when the energy storage system is in a discharging state and the remaining power of the battery pack correspondingly connected to each BMU meets a second preset condition, sending, by each BMU, a control signal to a switch unit correspondingly connected to each BMU, wherein the control signal is used for controlling the switch unit correspondingly connected to each BMU to perform disconnection processing on the battery pack correspondingly connected to each BMU, wherein the disconnection processing comprises disconnecting a current path of a battery pack correspondingly connected to each switch unit and ensuring that a current path of the energy storage system is connected.

17. The control method according to claim 16, wherein each of the N switch units comprises a first switch and a second switch, each BMU is separately connected to a first switch and a second switch in the switch unit correspondingly connected to each BMU, and each of the N battery packs is connected in series to a first switch in the switch unit correspondingly connected to each battery pack, to obtain a sub-circuit corresponding to each battery pack, and a second switch in the switch unit correspondingly connected to each battery pack is connected in parallel to the sub-circuit corresponding to each battery pack; and
sending, by each BMU, the control signal to the switch unit correspondingly connected to each BMU comprises:
when the energy storage system is in a charging state and the remaining power of the battery pack correspondingly connected to each BMU meets the first preset condition, and/or when the energy storage system is in a discharging state and the remaining power of the battery pack correspondingly connected to each BMU meets the second preset condition, sending a first control signal to the first switch in the switch unit correspondingly connected to each BMU, and sending a second control signal to the second switch in the switch unit correspondingly connected to each BMU, wherein the first control signal is used for controlling a switch to be turned off, and the second control signal is used for controlling a switch to be turned on.

18. The control method according to claim 17, wherein the energy storage system further comprises a battery control unit (BCU), wherein
the method further comprises:
receiving, by each BMU, control indication information sent by the BCU, wherein the control indication information indicates to the BMU to control the correspondingly connected switch unit to perform disconnection processing on the correspondingly connected battery pack, wherein
sending, by each BMU, the first control signal to the first switch in the switch unit correspondingly connected to each BMU, and sending the second control signal to the second switch in the switch unit correspondingly connected to each BMU comprises:
sending, by each BMU based on the control indication information, the first control signal to the first switch in the switch unit correspondingly connected to each BMU, and sending the second control signal to the second switch in the switch unit correspondingly connected to each BMU.
